(19) United States
(12) Patent Application Publication
(10) Pub. No.: US 2026/0357637 A1
(43) Pub. Date: Nov. 12, 2026

(54) SYSTEM AND METHOD FOR TAILGATE CONTROL

(71) Applicants: Hyundai Motor Company, Seoul (KR); Kia Corporation, Seoul (KR)

(72) Inventors: Yun Xiang DENG, Yantai (CN); Yi Jin ZHAO, Yantai (CN); Li Chen XIE, Yantai (CN); Cheng Kai ZHANG, Yantai (CN); Ya Xiong LIU, Yantai (CN); Wen Yan YU, Yantai (CN)

(21) Appl. No.: 19/382,760

(22) Filed: Nov. 7, 2025

(30) Foreign Application Priority Data
May 8, 2025 (CN) 202510593219.5

(51) Int. Cl. E05F 15/77; E05F 15/73

(52) U.S. Cl. CPC E05F 15/77; E05F 2015/767; E05Y 2900/546

(57) ABSTRACT

Disclosed is a system and a method for rear gate control. The system may include: a first sensor installed on at least one of a front portion or a rear portion of a vehicle, and configured to acquire first sensor data of a surrounding environment of the vehicle; a second sensor installed in a storage space of the vehicle and configured to acquire second sensor data of the storage space; and a control circuit configured to: acquire, based on the first sensor data, object information related to an object in the surrounding environment of the vehicle; acquire, based on the second sensor data, storage information related to the storage space; select, based on the object information and the storage information, a position of a rear gate of the vehicle (e.g., a fully open position or a semi-open position); and control the rear gate to move to the selected position.

### CROSS-REFERENCE TO RELATED APPLICATION

This application claims priority to Chinese Patent Application No. 202510593219.5, filed May 8, 2025, the disclosure of which is incorporated herein by reference in its entirety.

### TECHNICAL FIELD

The present disclosure relates to a tailgate of a vehicle, and more particularly to a system and a method for tailgate control.

### BACKGROUND

Tailgates of many vehicles are designed to swing backwards to open, such that the tailgates may not be fully opened if there is not enough clearance between the rear end of the vehicle and an obstacle in the back (e.g., a wall) after the vehicle is parked. Even if the tailgate can be fully opened, a vehicle user may need to step back or to the side in order to avoid contact with the tailgate being opened, which may cause inconvenience or injury. In addition, if there is available storage space or the object that is to be stowed in the storage space is relatively small, completely opening the relatively large tailgate may not be necessary.

### SUMMARY

The present disclosure provides a system and a method for a tailgate control, which may select an open state of a tailgate to be used between a fully open state or a semi-open state of the tailgate according to portable information of a vehicle user and storage information of a storage space, thereby preventing the time for taking out or loading an object from being extended due to an erroneous selection by the user.

Problems to be solved by the present disclosure are not limited to those mentioned above, and other problems not mentioned will be clearly understood by those of ordinary skill in the art from the following description.

According to one or more example embodiments of the present disclosure, a system may include: a first sensor installed on at least one of a front portion or a rear portion of a vehicle, and configured to acquire first sensor data of a surrounding environment of the vehicle; a second sensor installed in a storage space of the vehicle and configured to acquire second sensor data of the storage space; and a control circuit configured to: acquire, based on the first sensor data, object information related to an object in the surrounding environment of the vehicle; acquire, based on the second sensor data, storage information related to the storage space; select, based on the object information and the storage information, a position of a rear gate of the vehicle; and control the rear gate to move to the selected position. The selected position may be one of: a fully open position in which the rear gate fully uncovers an opening of the storage space, or a semi-open position in which the rear gate partially covers the opening of the storage space.

The control circuit may be configured to select the position of the rear gate by: acquiring a size of a partial opening of the storage space with the rear gate in the semi-open position. The size may include an opening height in a vertical direction of the vehicle and an opening length in a lateral direction of the vehicle; determining, based on the object information, whether the object is being carried by a vehicle user; determining, based on determining that the object is being carried by the vehicle user, whether a size of the object oriented in a specific direction falls within the size of the partial opening with the rear gate in the semi-open position; determine, based on the storage information and based on determining that the size of the object oriented in the specific direction falls within the size of the partial opening with the rear gate in the semi-open position, whether a height of a second object that is stored in the storage space is greater than or equal to the opening height of the storage space with the rear gate in the semi-open position; and select the position of the rear gate by selecting one of: the fully open position, based on determining that the height of the second object is greater than or equal to the opening height of the storage space with the rear gate in the semi-open position; or the semi-open position, based on determining that the height of the second object is less than the opening height of the storage space with the rear gate in the semi-open position.

The control circuit may be configured to select the position of the rear gate by: selecting the fully open position based on determining that the size of the object oriented in the specific direction falls beyond the size of the partial opening with the rear gate in the semi-open position.

The control circuit may be further configured to: acquire, based on the first sensor data, a height of the vehicle user; and determine, after selecting the position of the rear gate and based on the height of the vehicle user and the selected position of the rear gate, a reference value for determining whether a space behind the vehicle is sufficient for opening the rear gate.

The system may further include: a third sensor installed on the rear portion of the vehicle and configured to acquire third sensor data of the space behind the vehicle. The control circuit may be configured to determine whether the space behind the vehicle is sufficient for opening the rear gate by: acquiring, based on the third sensor data, a longitudinal length of the space behind the vehicle; determining that: the space behind the vehicle is sufficient for opening the rear gate based on the longitudinal length of the space behind the vehicle being greater than the reference value; or the space behind the vehicle is insufficient for opening the rear gate based on the longitudinal length of the space behind the vehicle being less than or equal to the reference value.

The control circuit may be configured to control the rear gate by: outputting, based on determining that the space behind the vehicle is insufficient, a notification for asking whether to move the vehicle; activating, based on receiving a user input for moving the vehicle, an automatic parking function to move the vehicle until the space behind the vehicle becomes sufficient for opening the rear gate; and controlling, after determining that the space behind the vehicle is sufficient for opening the rear gate, the rear gate to open.

The control circuit may be configured to select the position of the rear gate by: selecting the position of the rear gate further based on a user control command for opening the rear gate.

The control circuit may be further configured to: determine, based on a user terminal associated with the vehicle user, whether the vehicle user stays, for at least a reference time duration, within a predetermined distance from the rear gate; and, based on the vehicle user staying within the predetermined distance from the rear gate for at least the reference time duration, control the vehicle to move or control the rear gate to open.

The control circuit may be further configured to: determine, after controlling the rear gate to open, whether a user control command for closing the rear gate has been input; and control, based on determining that the user control command for closing the rear gate has been input, the rear gate to close.

The system may further include: a fourth sensor installed in a lower portion of the rear gate. The lower portion of the rear gate may be configured to, in a closed position of the rear gate, cover a lower portion of the opening of the storage space. The fourth sensor may be configured to acquire fourth sensor data of a rear of the rear gate in the semi-open position. The control circuit may be further configured to perform one of: acquiring, after controlling the rear gate to open to the semi-open position and based on the fourth sensor data, a hand gesture of the vehicle user; or acquiring, after controlling the rear gate to open to the fully open position and based on the first sensor data, the hand gesture of the vehicle user. The control circuit may be further configured to: determine whether the acquired hand gesture of the vehicle user is a predetermined hand gesture for closing the rear gate; and control, based on determining that the hand gesture of the vehicle user is the predetermined hand gesture for closing the rear gate, the rear gate to close.

The system may further include: a projection lamp installed on the rear portion of the vehicle and configured to project light onto a ground surface behind the vehicle to indicate a position of the vehicle user. The control circuit may be configured to cause the projection lamp to project the light before: controlling the rear gate to open based on determining that the space behind the vehicle is sufficient for opening the rear gate, or controlling the rear gate to close based on receiving a user input for closing the rear gate.

The control circuit may be configured to control the projection lamp by: controlling the projection lamp to project the light at a projection area. A minimum longitudinal distance between a rear end of the vehicle and the projection area may be one of: based on the selected position of the rear gate being the semi-open position, a first maximum longitudinal distance between the rear end of the vehicle and a first movement trajectory of the rear gate between a closed position and the semi-open position; based on the selected position of the rear gate being the fully open position and based on the height of the vehicle user being greater than or equal to a minimum height of the rear gate at the fully open position, a second maximum longitudinal distance between the rear end of the vehicle and a second movement trajectory of the rear gate between the closed position and the fully open position; or, based on the selected position of the rear gate being the fully open position and based on the height of the vehicle user being less than the minimum height of the rear gate at the fully open position, a longitudinal distance between the rear end of the vehicle and a point, on the second movement trajectory, that corresponds to the height of the vehicle user.

The control circuit may be further configured to: after controlling the projection lamp to project the light and before controlling the rear gate to open or close, acquire, based on the third sensor data, the position of the vehicle user; determine whether the acquired position of the vehicle user is in the projection area or further away from the rear end of the vehicle than the projection area; and control, based on determining that the position of the vehicle user is further away from the rear end of the vehicle than the projection area, the rear gate to open or close.

The first sensor may include a front camera installed on the front portion of the vehicle and a rear camera installed on the rear portion of the vehicle. The control circuit may be configured to: determine, based on a user terminal associated with a vehicle user, a direction in which the vehicle user is located relative to the vehicle when the vehicle user approaches the vehicle; and activate, based on the direction, a corresponding one of the front camera or the rear camera.

According to one or more example embodiments of the present disclosure, a method performed by a device associated with a vehicle may include: acquiring, based on first sensor data of a surrounding environment of the vehicle, object information related to an object in the surrounding environment of the vehicle; acquiring, based on second sensor data of a storage space of the vehicle, storage information related to the storage space; selecting, based on the object information and the storage information, a position of a rear gate of the vehicle; and controlling the rear gate to move to the selected position. The selected position may be one of: a fully open position in which the rear gate fully uncovers an opening of the storage space, or a semi-open position in which the rear gate partially covers the opening of the storage space; and

Selecting the position of the rear gate may include: acquiring a size of a partial opening of the storage space with the rear gate in the semi-open position. The size may include an opening height in a vertical direction of the vehicle and an opening length in a lateral direction of the vehicle; determining, based on the object information, whether the object is being carried by a vehicle user; determining, based on determining that the object is being carried by the vehicle user, whether a size of the object oriented in a specific direction falls within the size of the partial opening with the rear gate in the semi-open position; determining, based on the storage information and based on determining that the size of the object oriented in the specific direction falls within the size of the partial opening with the rear gate in the semi-open position, whether a height of a second object that is stored in the storage space is greater than or equal to the opening height of the storage space with the rear gate in the semi-open position; and selecting the position of the rear gate by selecting one of: the fully open position, based on determining that the height of the second object is greater than or equal to the opening height of the storage space with the rear gate in the semi-open position; or the semi-open position, based on determining that the height of the second object is less than the opening height of the storage space with the rear gate in the semi-open position.

Selecting the position of the rear gate may include: selecting the fully open position based on determining that the size of the object oriented in the specific direction falls beyond the size of the partial opening with the rear gate in the semi-open position.

The method may further include: acquiring, based on the first sensor data, a height of the vehicle user; and determining, after selecting the position of the rear gate and based on the height of the vehicle user and the selected position of the rear gate, a reference value for determining whether a space behind the vehicle is sufficient for opening the rear gate.

Determining whether the space behind the vehicle is sufficient for opening the rear gate may include: acquiring, based on third sensor data of the space behind the vehicle, a longitudinal length of the space behind the vehicle; determining that: the space behind the vehicle is sufficient for opening the rear gate based on the longitudinal length of the space behind the vehicle being greater than the reference value; or the space behind the vehicle is insufficient for opening the rear gate based on the longitudinal length of the space behind the vehicle being less than or equal to the reference value.

Controlling the rear gate may include: outputting, based on determining that the space behind the vehicle is insufficient, a notification for asking whether to move the vehicle; activating, based on receiving a user input for moving the vehicle, an automatic parking function to move the vehicle until the space behind the vehicle becomes sufficient for opening the rear gate; and controlling, after determining that the space behind the vehicle is sufficient for opening the rear gate, the rear gate to open.

Selecting the position of the rear gate may include: selecting the position of the rear gate further based on a user control command for opening the rear gate.

The method may further include: determining, based on a user terminal associated with the vehicle user, whether the vehicle user stays, for at least a reference time duration, within a predetermined distance from the rear gate; and, based on the vehicle user staying within the predetermined distance from the rear gate for at least the reference time duration, controlling the vehicle to move or controlling the rear gate to open.

The method may further include: determining, after controlling the rear gate to open, whether a user control command for closing the rear gate has been input; and controlling, based on determining that the user control command for closing the rear gate has been input, the rear gate to close.

The method may further include one of: acquiring, after controlling the rear gate to open to the semi-open position and based on fourth sensor data of a rear of the rear gate in the semi-open position, a hand gesture of the vehicle user; or acquiring, after controlling the rear gate to open to the fully open position and based on the first sensor data, the hand gesture of the vehicle user. The method may further include: determining whether the acquired hand gesture of the vehicle user is a predetermined hand gesture for closing the rear gate; and controlling, based on determining that the hand gesture of the vehicle user is the predetermined hand gesture for closing the rear gate, the rear gate to close.

The method may further include: controlling a projection lamp to project light onto a ground surface behind the vehicle to indicate a position of the vehicle user, before: controlling the rear gate to open based on determining that the space behind the vehicle is sufficient for opening the rear gate, or controlling the rear gate to close based on receiving a user input for closing the rear gate.

Controlling the projection lamp may include: controlling the projection lamp to project the light at a projection area. A minimum longitudinal distance between a rear end of the vehicle and the projection area may be one of: based on the selected position of the rear gate being the semi-open position, a first maximum longitudinal distance between the rear end of the vehicle and a first movement trajectory of the rear gate between a closed position and the semi-open position; based on the selected position of the rear gate being the fully open position and based on the height of the vehicle user being greater than or equal to a minimum height of the rear gate at the fully open position, a second maximum longitudinal distance between the rear end of the vehicle and a second movement trajectory of the rear gate between the closed position and the fully open position; or, based on the selected position of the rear gate being the fully open position and based on the height of the vehicle user being less than the minimum height of the rear gate at the fully open position, a longitudinal distance between the rear end of the vehicle and a point, on the second movement trajectory, that corresponds to the height of the vehicle user.

The method may further include: after the controlling of the projection lamp to project the light and before the controlling of the rear gate to open or close, acquiring, based on the third sensor data, the position of the vehicle user; determining whether the acquired position of the vehicle user is in the projection area or further away from the rear end of the vehicle than the projection area; and controlling, based on determining that the position of the vehicle user is further away from the rear end of the vehicle than the projection area, the rear gate to open or close.

### BRIEF DESCRIPTION OF THE DRAWINGS

One or more example embodiments of the present disclosure will now be described in more detail with reference to the accompanying drawings. For clarity, the same members are denoted by the same reference numerals in different drawings. It is noted that the accompanying drawings serve only as illustrations and are not necessarily to scale. In this figure:

FIG. 1 is a block diagram of an example tailgate control system of a vehicle.

FIG. 2 is a schematic diagram for an example two-stage tailgate in a semi-open state and a closed state.

FIG. 3 is a schematic diagram for size comparisons between objects to be stowed and an opening to a storage space of an example tailgate in a semi-open state.

FIGS. 4A and 4B are schematic diagrams for size comparisons of an object stored in a storage space with an opening to a storage space of an example tailgate in a semi-open state.

FIGS. 5A and 5B are operational flow diagrams of an example controlling method for opening a tailgate.

FIG. 6 is a schematic view of rear vehicle clearance required for opening a one-stage tailgate and a two-stage tailgate.

FIG. 7 is a schematic diagram of calculating a reference value when an example two-stage tailgate is opened in a semi-open state.

FIGS. 8A and 8B are schematic diagrams for calculating a reference value when an example two-stage tailgate is opened in a fully open state.

FIG. 9 is an operational flow diagram of an example controlling method for closing a tailgate.

FIG. 10 is a flowchart of an example tailgate control method.

FIG. 11 shows an example computing system.

### DETAILED DESCRIPTION

The following is a detailed description of one or more example embodiments of the present disclosure. The example embodiment(s) are implemented based on the technical solutions of the present disclosure, and provide details and specific operation processes. However, the protection scope of the present disclosure is not limited to the example embodiment(s) described herein.

A tailgate controlled by a system and a method according to the present disclosure refers to a two-stage tailgate that may be opened in a semi-open or fully open state. When the tailgate is opened in the fully open state, a storage space of the vehicle rear portion is fully opened, and when the tailgate is open in the semi-open state, the lower half portion of the storage space of the vehicle rear portion is opened. The open state of the tailgate may include the fully open state that fully opens the storage space of the vehicle rear portion or the semi-open state that opens at least a portion of the storage space of the vehicle rear portion.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

A vehicle (also referred to as a mobility apparatus or a mobility device) may be any apparatus or device capable of movement. A vehicle may be capable of movement by means of self-propulsion using, for example, one or more motors or engines. A vehicle may be capable of traversing over and/or across different terrains and spaces, such as land, underground, air, space, sea, and/or underwater. Land or underground vehicle may be provided, for example, in the form of automobiles, cars, trucks, buses, motorcycles, mopeds, bicycles, mobility scooters, robots, etc. Air or space vehicles may be provided, for example, in the form of air mobility apparatuses, such as fixed-wing or rotary-wing aircraft, advanced air mobility (AAM) devices, unmanned aerial vehicles, drones, rockets, or vehicles mounted on satellites. Marine or underwater vehicles may include, for example, ships, boats, jet skis, hovercraft, submarines, etc. A vehicle may move across multiple terrains or spaces.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining clearance for opening and closing a tailgate) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining clearance for opening and closing a tailgate) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining clearance for opening and closing a tailgate) described herein.

Minimum risk maneuver (MRM) operation(s) may also be controlled, for example, based on one or more features (e.g., determining clearance for opening and closing a tailgate) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining clearance for opening and closing a tailgate) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., determining clearance for opening and closing a tailgate) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining clearance for opening and closing a tailgate) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). For example, the operation control for autonomous driving of the vehicle may include moving the vehicle (e.g., autonomously moving the vehicle forward) until there is a sufficient space (e.g., clearance for opening a rear gate) behind the vehicle.

A tailgate may be a door or opening of a cargo area of a vehicle. The cargo area may be located at the rear of the vehicle. The cargo area may also be referred to as a trunk, a cargo hold, a storage space, a storage area, a storage compartment, a luggage compartment, etc. The tailgate may be hinged at the top, side, or bottom of the opening of the cargo area. The tailgate may be, for example, a door, a backdoor, a rear door, a rear gate, a rear access door, a liftgate, a hatch, a rear hatch, a lid, a rear lid, a trunk lid, etc. A vehicle having a tailgate in the rear may be, for example, a sedan, a van, a minivan, a sport utility vehicle (SUV), a multi-purpose vehicle (MPV), a wagon, etc.

A two-stage tailgate (also referred to as a two-step tailgate, a two-piece tail gate, etc.) may include an upper tailgate and a lower tailgate. If the two-stage tailgate is in the semi-open state, the lower tailgate may move rearward of the upper tailgate and be placed in a position parallel to the upper tailgate. If the two-stage tailgate is in the fully open state, the upper tailgate and the lower tailgate, which may have been previously in the semi-open state, may be lifted together to a position parallel to the ground.

The two-stage tailgate may reduce the rear space of the vehicle required (e.g., clearance) when opening the tailgate, but, at least in some implementations, the user may only manually select the fully open state or the semi-open state of the two-stage tailgate. Specifically, the two-stage vehicle tailgate may be provided with a semi-open button and a full-open button that may be pressed by a user. In this case, the user may need to estimate the size of the object to be put in, but if the size of the object is incorrectly estimated, it is possible to select an incorrect mode (e.g., the fully open state or the semi-open state) of the tailgate. For example, if the user erroneously assumes that the object is small in size and presses the semi-open button so that the tailgate is opened in a semi-open state, after the tailgate is open in the semi-open state and only after the user makes an attempt, it is found that the object may not be put into the storage space with the tailgate in the half-open state, and then the user has to press the fully-open button again. In addition, even if the user accurately estimates the size of the object, there may be a case where the user forgets that the object is already loaded in the lower half portion of the storage space, and only after the tailgate is opened in a semi-open state, the user finds that there is no space to put the object in the lower half portion of the storage space. When the user erroneously selects the fully open or semi-open state of the tailgate, the time to take things out or put them in may be extended.

The above description of the background art is only for facilitating an in-depth understanding of the technical solutions (the technical means used, the technical problem to be solved, the technical effect to be generated, and the like) of the present invention, and should not be regarded as acknowledging that the message constitutes the prior art known to those skilled in the art or implying it in any form.

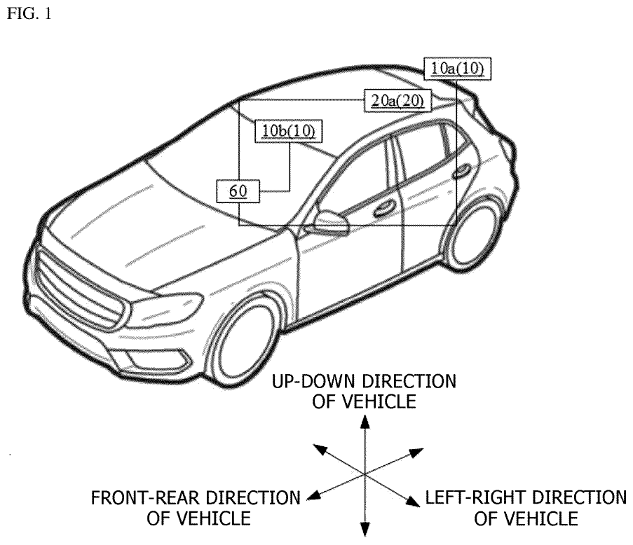

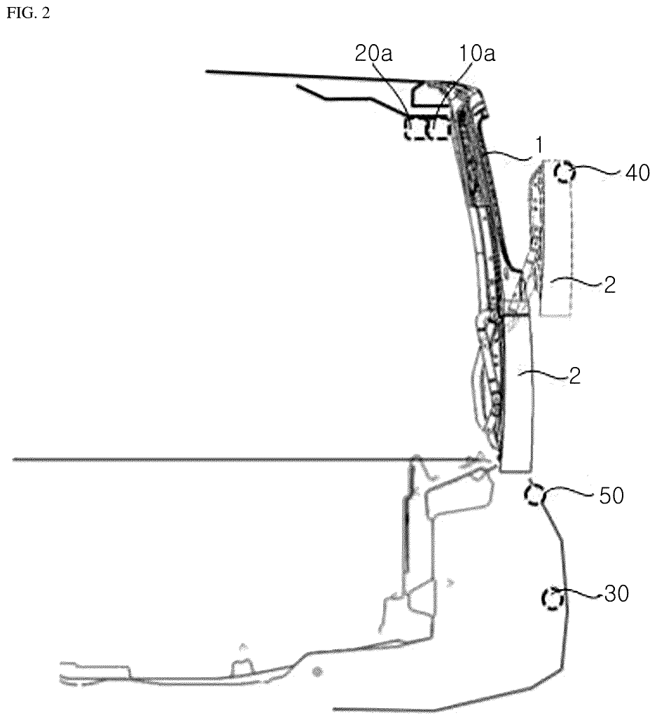

FIG. 1 is a block diagram of an example tailgate control system of a vehicle. FIG. 2 is a schematic diagram for an example two-stage tailgate in a semi-open state (dashed portion) and a closed state (solid portion).

Referring to FIG. 1, hereinbelow, a front-rear direction (e.g., longitudinal direction) of a vehicle means a reference line direction from a front portion to a rear portion of the vehicle, a left-right direction (e.g., lateral direction) of the vehicle means the reference line direction from left to right of the vehicle, and an up-down direction (e.g., vertical direction) of the vehicle refers to the reference line direction to a roof from a wheel bottom.

A system for tailgate control may include a first sensor 10, a second sensor 20, and a controller (e.g., a control circuit) 60.

The first sensor 10 is installed on at least a front portion and a rear portion of the vehicle, and is configured to acquire sensor data of at least a front and a rear of the vehicle.

Specifically, the first sensor 10 may include a rear camera 10a and a front camera 10b. The rear camera 10a is installed on a rear portion of the vehicle, for example, as shown in FIG. 2, the rear camera 10a may be installed adjacent to an upper end portion of a rear glass window inside the vehicle, so that the rear camera 10a may take a vehicle rear image through the rear glass window. The vehicle rear image may then be used as sensor data of the rear of the vehicle. The front camera 10b is installed on a front portion of the vehicle, for example, the front camera 10b may be installed adjacent to an upper end portion of a windshield window inside the vehicle, so that the front camera 10B may take a vehicle front image through the windshield glass window. The vehicle front image may then be used as sensor data of the front of the vehicle.

Preferably, the rear camera 10a or the front camera 10b may be a wide-angle camera or an ultra-wide-angle camera having an angle of view of 180° or more.

However, the first sensor 10 is not limited to the rear camera 10a and the front camera 10b. In addition to the rear camera 10a and the front camera 10b, the first sensor 10 may further include a lateral camera (not shown) installed on a side mirror outside the vehicle and capable of acquiring a lateral view image of the vehicle. The image of the lateral view of the vehicle may be used as lateral sensor data of the vehicle. In other words, in this case, the first sensor 10 is configured to acquire sensor data around the vehicle.

The second sensor 20 is installed in a storage space of the rear portion of the vehicle, and is configured to acquire sensor data of the storage space.

Specifically, as shown in FIG. 2, the second sensor 20 may be a built-in camera 20a, and the built-in camera 20a may be installed at an upper end portion of the storage space, so that an image of the storage space may be acquired by the built-in camera 20a. The image of the storage space may then be used as sensor data of the storage space.

However, the type of the second sensor 20 is not limited to a camera, and the second sensor 20 may be a sensor such as a millimeter wave radar sensor, a lidar sensor, an infrared sensor, or the like.

Referring to FIG. 1, the first sensor 10 (specifically, the rear camera 10a and the front camera 10b) is electrically connected to the controller 60. The controller 60 may acquire portable information of a vehicle user according to the sensor data (including at least sensor data of the front and rear of the vehicle) acquired by the first sensor 10.

The portable information of the vehicle user may be portable information related to an object. The portable information of the vehicle user may include at least one of whether the vehicle user carries an object and size information of the object carried by the vehicle user. Specifically, the rear camera 10a and the front camera 10b may transmit the vehicle front image and the vehicle rear image as sensor data to the controller 60. After receiving the vehicle front image and the vehicle rear image, the controller 60 may identify the received vehicle front image and vehicle rear image. For example, when the vehicle front image is an image in which a vehicle user carries a 24-inch carrier, the controller 60 may identify a person shape of the vehicle user and a shape of the carrier connected to the person shape in the vehicle front image, so that the controller 60 may identify that the vehicle user carries an object, acquire information such as a length, a width, or a height of the carrier according to the identified shape of the carrier, and the controller 60 may use the identified information as the portable information of the vehicle user.

The second sensor 20 (specifically, the built-in camera 20a) is electrically connected to the controller 60. The controller 60 may acquire storage information of the storage space according to the sensor data acquired by the second sensor (that is, the sensor data of the storage space).

The storage information of the storage space includes whether an object is stored in the storage space and overall size information (or size information of each object) of the object stored in the storage space. Similarly, the built-in camera 20a may transmit storage space image of the vehicle rear portion as sensor data to the controller 60. After receiving the storage space image, the controller 60 may identify the received storage space image. For example, when a plurality of objects are stored in the storage space, the controller 60 may consider the length, width, and height of each object or a plurality of objects as a single object to identify the length, width and height of the single object, and the information identified by the controller 60 may be used as storage information of the storage space.

After acquiring the portable information of the vehicle user and the storage information of the storage space, the controller 60 may determine the open state of the tailgate to be used, according to the acquired portable information of the vehicle user and the acquired storage Information of the storage space. The tailgate may be a two-stage tailgate, that is, the controller 60 determines whether the state of the tailgate to be used is a fully open state or a semi-open state. In the fully open state (also referred to as a fully open position), a tailgate gate may fully uncover an opening to a storage space of the vehicle. In the semi-open state (also referred to as a semi-open position or partially open position) of the tailgate, the tailgate may partially cover (and/or partially uncover) the opening to the storage space of the vehicle.

The controller 60 may determine whether the vehicle user is carrying an object according to the portable information of the vehicle user. When the controller 60 determines that the vehicle user carries the object, the controller 60 may determine whether the size of the object projected in a specific direction falls within an opening size range of the storage space in a state in which the tailgate is semi-open according to the portable information of the vehicle user.

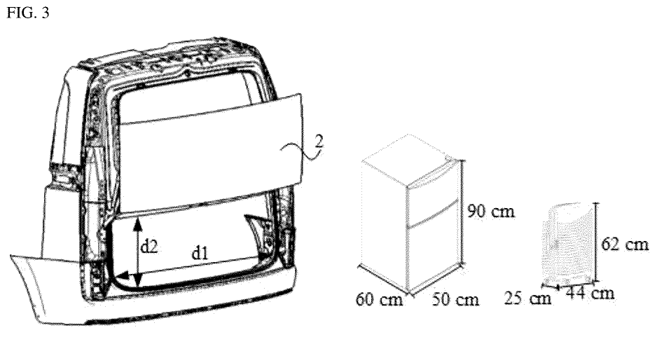

FIG. 3 is a schematic diagram for size comparisons between objects to be stowed and an opening to a storage space of an example tailgate in a semi-open.

Specifically, FIG. 3 shows that the tailgate is opened in a semi-open state and an opening is formed in a lower half portion of the storage space. The opening size of the storage space in a state in which the tailgate is semi-open means the length d1 in the left-right direction of the vehicle and the length d2 in the up-down direction of the vehicle. By way of example, the length d1 may be about 120 cm and the length d2 may be about 46 cm.

The information on the opening size of the storage space in a state in which the tailgate is semi-open is preset and stored in a memory (not shown), and may be acquired by the controller 60.

FIG. 3 illustrates two objects that a vehicle user may carry. The object that the vehicle user may carry shown in FIG. 3 is close to a rectangular parallelepiped, and below, a process in which the controller 60 compares the size of the object carried by the vehicle user with the size of the opening of the storage space in a state in which the tailgate is semi-open is described as an example of the object close to the rectangular parallelepiped. However, in real life, the object carried by the vehicle user is not limited to a specific shape, and in the case of an object having another shape (e.g., a sphere, a cylinder) or an irregular shape, the controller 60 may perform the same comparison process.

As shown in FIG. 3, when the portable object is a small refrigerator having a length of 50 cm, a width of 60 cm, and a height of 90 cm, the size of the object projected in the width direction is 50 cm×90 cm, and is 50 cm>46 cm and 90 cm>46 cm when compared with the opening size of the storage space of 120 cm×46 cm in a state in which the tailgate is semi-open. Therefore, the size of 50 cm×90 cm does not fall within the opening size range of 120 cm×46 cm. In other words, when the vehicle user attempts to put the object into the storage space in the width direction, although the opening length d1 in the left-right direction of the vehicle is sufficient, the opening length d2 in the up-down direction of the vehicle becomes insufficient, and the object may not pass through the opening of the storage space in a state in which the tailgate is semi-open. In addition, since the size of the object projected in the longitudinal direction is 60 cm×90 cm and the size of the objects projected in the height direction is 50 cm×60 cm, when compared with the opening size of the storage space of 120 cm×46 cm in a state in which the tailgate is semi-open, these sizes also do not fall within the opening size range of 120 cm×46 cm, and the object may not pass through the opening of the storage space in the depth direction and the height direction in a state in which a tailgate is semi-open, and the reason why the object may not pass therethrough is that the opening length d2 in the up-down direction of the vehicle is insufficient. It will also be appreciated that even if the vehicle user attempts to put an object in the storage space in a width direction, a length direction, or another direction having an arbitrary deflection angle with a height direction, the object may not pass through the opening in the storage space in a state in which a tailgate is semi-open.

In other words, the controller 60 may determine that the size of the object projected in a specific direction does not fall within the range of the size of the opening of the storage space in the state in which the tailgate is semi-open, based on the size 50 cm×90 cm×60 cm of the object carried by the vehicle user and the opening size 120 cm×46 cm of the storage space in a state in which the tailgate is semi-open. That is, the size of the object projected in any direction all exceeds the range of the opening size of the storage space in a state in which the tailgate is semi-open. This means that the object carried by the vehicle user is large and may not pass through the opening of the storage space in a state in which the tailgate is semi-open, and thus may not be loaded into the storage space, so that the controller 60 may determine the open state of the tailgate to be used as the fully open state.

In another case, as shown in FIG. 3, when the carried object is a 24-inch carrier having a length of 44 cm, a width of 25 cm, and a height of 62 cm, the size of the object projected in the height direction is 44 cm×25 cm, and is 44 cm<120 cm and 25 cm<46 cm when compared with the opening size of the storage space of 120 cm×46 cm in a state in which the tailgate is semi-open, so that the size of 44 cm×25 cm falls within the opening size range of 120 cm×46 cm. In other words, when the vehicle user attempts to load the object in the storage space in the height direction, both the opening length d1 in the left-right direction of the vehicle and the opening length d2 in the up-down direction of the vehicle are sufficient, so that the object may pass through the opening of the storage space in a state in which the tailgate is semi-open.

Therefore, the controller 60 may determine that the size of the object projected in a specific direction falls within a range of the size of the opening of the storage space in a state in which the tailgate is semi-open, based on the size 44 cm×62 cm×25 cm of the object carried by the vehicle user and the opening size 120 cm×46 cm of the storage space in a state in which the tailgate is semi-open, for example, the specific direction may be a height direction. This means that the object carried by the vehicle user is small and may fit through the opening of the storage space in a state in which the tailgate is semi-open.

However, when an object is already stored in the current storage space and the stored object closes the opening of the storage space in a state in which the tailgate is semi-open, even if an object carried by the vehicle user may pass through the opening of the reception space in a state in which the tailgate is semi open, since the vicinity of the opening is closed, the object may not be loaded in the storage space. In other words, at this time, the controller 60 may not yet determine whether to make the open state of the tailgate to be used a semi-open state.

When determining that the size of the object projected in the specific direction falls within the opening size range of the storage space in the state in which the tailgate is semi-open, the controller 60 further determines, according to the storage information of the storage space, whether the height of the object stored in the storage space is equal to or greater than the opening length of the storage space toward the vehicle up-down direction in the state in which a tailgate is semi-open.

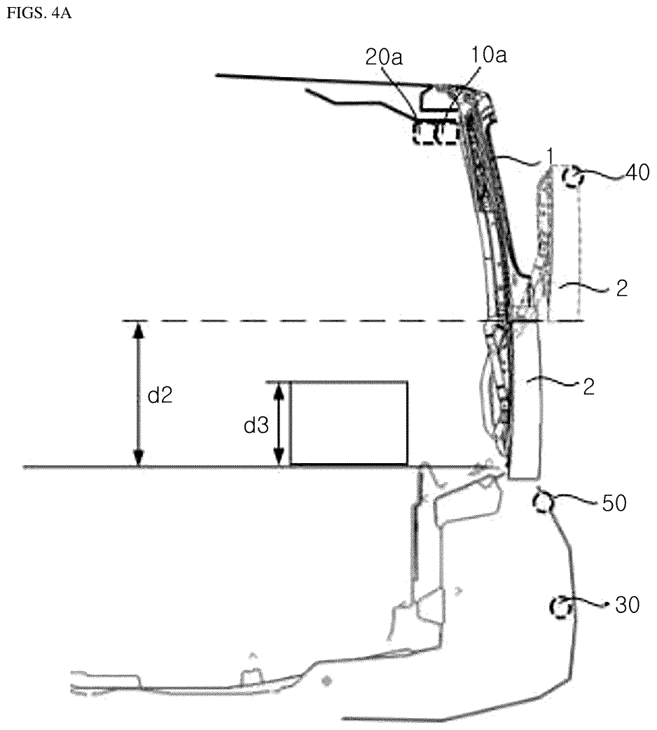

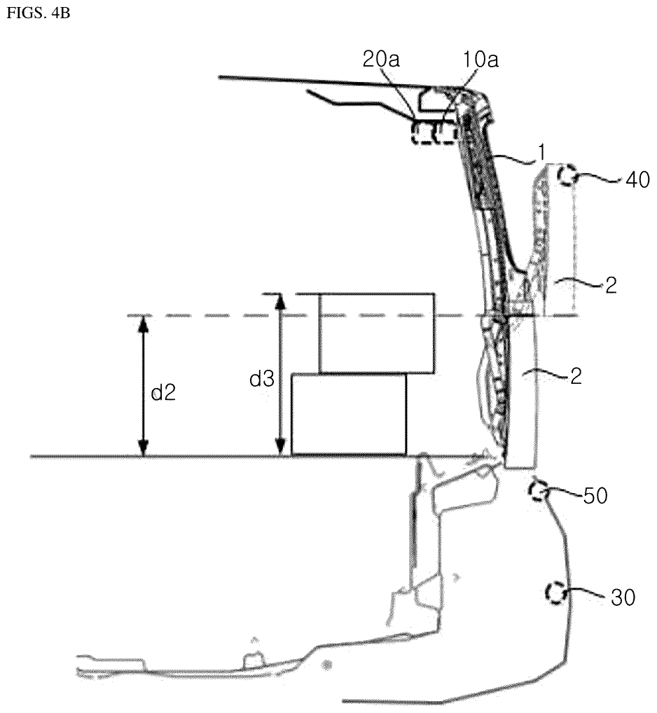

FIGS. 4A and 4B are schematic diagrams for size comparisons of an object stored in a storage space with an opening to a storage space of an example tailgate in a semi-open state.

As shown in FIG. 4A, when the controller 60 determines that the height d3 of the object stored in the storage space is smaller than the opening length d2 of the storage space in the up-down direction of the vehicle in a state in which the tailgate is semi-open, it means that the lower half space of the storage space is sufficient, and the small object carried by the vehicle user may be loaded into the storage space. At this time, the controller 60 may determine the open state of the tailgate to be used as the semi-open state.

Conversely, as shown in FIG. 4B, when the controller 60 determines that the height d3 of the object stored in the storage space is equal to or greater than the opening length d2 of the storage space in the up-down direction of the vehicle in a state in which the tailgate is semi-open, it means that the lower half space of the storage space is insufficient, and even if the object carried by the vehicle user is a relatively small object, the object may not be loaded into the storage space, and the tailgate is opened in a fully open state, and the object must be loaded through the upper half portion of the storage space. At this time, the controller 60 may determine the open state of the tailgate to be used as the fully open state.

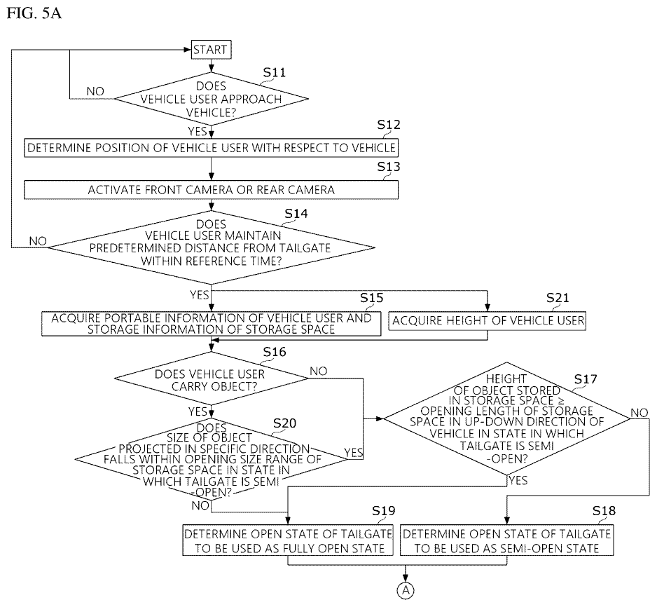

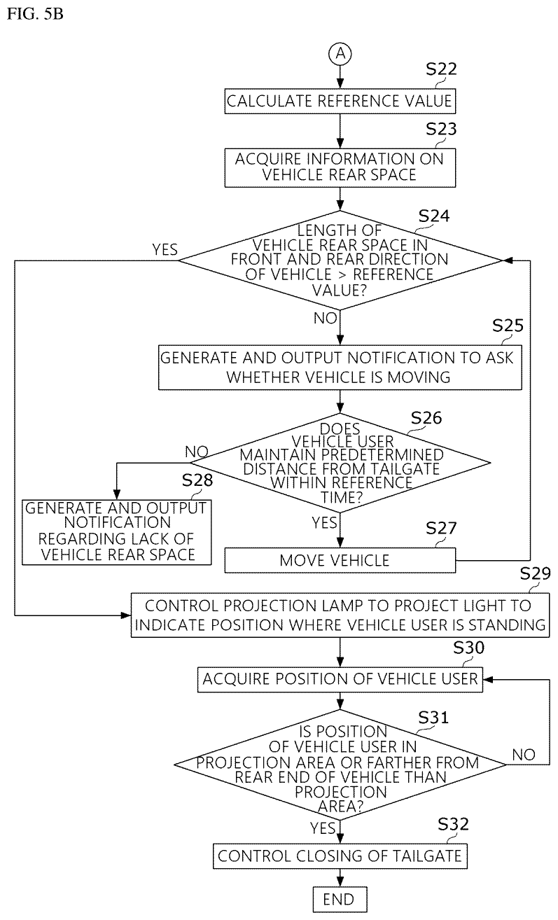

Although the operation of determining the open state of the tailgate to be used by the controller 60 has been described in detail above, in order to finally open the tailgate to the corresponding state, it is necessary to determine whether the vehicle user inputs a control command for opening the tailgate, whether the rear space of the vehicle is sufficient for the tailgate to open to the corresponding state and the like. FIGS. 5A and 5B are operational flow diagrams of an example controlling method for opening the tailgate. Hereinafter, with reference to FIG. 5A and FIG. 5B, an operation for opening a tailgate to be used by the tailgate control system in a determined open state will be described in detail.

As illustrated in FIG. 5A, the controller 60 may determine whether the vehicle user approaches the vehicle (S11). Specifically, a wireless communication module for short-range communication, for example, a Bluetooth module, a UWB module, or the like is installed in a front portion, a rear portion, a left side portion, and a right side portion of the vehicle, respectively. The controller 60 may control a plurality of wireless communication modules to transmit a request signal, and the request signal may form a detection area covering a preset range outside the vehicle with a predetermined distance as a transmission radius. When the vehicle user carries the user terminal and enters the detection area, the user terminal may transmit a response signal in response to the request signal, and the response signal is received by the wireless communication module. One of the wireless communication modules may be set as a master module, and the master module may collect a response signal received from another wireless communication module and transmit the response signal to the controller 60. Accordingly, the controller 60 may determine that the user terminal is located within the detection range, that is, that the vehicle user has approached the vehicle, according to the response signal transmitted by the user terminal.

Specifically, the user terminal may be a mobile device (e.g., a smartphone) equipped with a remote control key such as a fob key, a card key, or a vehicle key application.

When the controller 60 determines that the vehicle user has approached the vehicle (“YES” in S11), the controller 60 may further determine the position of the vehicle user with respect to the vehicle (S12). The location of the vehicle user relative to the vehicle includes a distance between the vehicle and the vehicle user and a direction in which the vehicle user is located relative to the vehicle.

For example, the controller 60 may measure a difference value between the time delay of the request signal and the response signal between the user terminal and the two or more wireless communication modules, and calculate the position of the user terminal with respect to the vehicle by using a method such as triangulation. However, the algorithm for calculating the position of the user terminal with respect to the vehicle is not limited thereto, and the controller 60 may calculate the position of the user's terminal with respect to a vehicle through an angle of arrival (AOA) method, a two-way ranging (TWR), a received signal strength indicator (RSSI) method, or the like.

In other words, the controller 60 determines a direction in which the vehicle user is positioned with respect to the vehicle when the vehicle user approaches the vehicle according to the user terminal carried by the vehicle user, and the controller 60 may activate a corresponding one of the front camera 10b and the rear camera 10a according to the determined direction in which the vehicle user is positioned with regard to the vehicle (S13). Specifically, when the vehicle user approaches the vehicle from the front of the vehicle, the controller 60 may determine that the user terminal is located in front of the vehicle and activate the front camera 10b, so that the vehicle user is always included in the vehicle front image captured by the front camera 10b. When the vehicle user approaches the vehicle from the rear of the vehicle, the controller 60 may determine that the user terminal is located at the rear of the vehicle, and activate the rear camera 10a, so that the vehicle user is always included in the vehicle rear image captured by the rear camera 10b.

Objects approaching the vehicle may vary, such as, for example, other vehicles driving in and out, pedestrians passing by, and the like. As described above, when setting the activation condition on the first sensor 10 (specifically, the front camera 10b and the rear camera 10a) may prevent the first sensor 10 from acquiring sensor data of other unnecessary objects, and in the process of the controller 60 recognizing the vehicle front image and the vehicle rear image, it may be ensured that the person shape recognized by the controller 60 is always the vehicle user, not the passerby or the like.

With the first sensor 10 activated, the first sensor 10 acquires sensor data of at least front of and rear of the vehicle. In addition, the second sensor 20 acquires sensor data of the storage space disposed in the vehicle rear portion. Before determining the open state of the tailgate to be used based on the sensor data acquired by the first sensor 10 and the second sensor 20, the controller 60 determines whether the vehicle user inputs a control command for opening the tailgate.

The controller 60 may determine whether the vehicle user maintains a predetermined distance (for example, 0.5 m, 1 m, or the like) from the tailgate within a reference time (for example, 3 seconds) according to the user terminal carried by the vehicle user (S14). For example, the controller 60 may determine, based on the user terminal associated with the vehicle user, whether the vehicle user maintains the predetermined distance (e.g., keeps within the predetermined distance or keeps at least the predetermined distance) from the tailgate for at least a reference time duration (e.g., 3 seconds). When the user terminal maintains the predetermined distance from the tailgate within the reference time (“YES” in S14), it means that the vehicle user maintains a stopped state near the tailgate, and accordingly, the controller 60 may determine that the vehicle user inputs a control command for opening the tailgate.

However, the manner of determining whether the vehicle user has input a control command for opening the tailgate is not limited thereto. For example, similarly to indicating that the vehicle user has input a control command for opening the tailgate by maintaining the vehicle user stationary near the tailgate, the controller 60 may acquire a vehicle rear image, that is, an image in which the vehicle user is present, from the rear camera 10a, and the controller 60 may determine whether the vehicle user maintains a predetermined distance (e.g., 0.5 m, 1 m, etc.) from the tailgate within a reference time (e.g., 3 seconds) based on the vehicle rear image, and thus determine whether the vehicle user has input the control command for opening of the tailgate.

If the vehicle user wants to open the tailgate, the user may press a tailgate button of the user terminal (e.g., fob key). Thus, the fob key may send a button press signal to the controller 60 to open the tailgate, and when receiving the button press signal to open the tailgate, the controller 60 may determine that the vehicle user has input a control command for opening the tailgate. Alternatively, when the vehicle user wants to open the tailgate, the vehicle user may say “open the tailgate,” and a voice receiving device installed in the tailgate may receive a voice signal of the vehicle user, so that the voice receiving device sends the voice signal of the vehicle user to the controller 60, and when receiving the voice signal of this vehicle user, the controller 60 may recognize the voice signal of that vehicle user, and determine that the vehicle user inputs a control command for opening the tailgate according to the recognized result.

In other words, according to the present disclosure, the control command (including the control command for opening the tailgate already mentioned and the control command for moving the vehicle and closing the tailgate to be described later) input by the vehicle user may be an operation command (for example, a hand gesture operation, a face operation, or the like) or other kinds of commands (for example, button press signals, knob signals, voice signals, or the like), respectively.

When the user terminal maintains a predetermined distance from the tailgate for the reference time (“YES” in S14), that is, only when the vehicle user inputs a control command for opening the tailgate, the controller 60 may enter an operation of determining an open state of the tailgate to be used.

Specifically, the controller 60 acquires the portable information of the vehicle user according to the sensor data of the first sensor 10, and acquires the storage information of the storage space according to the sensor information of the second sensor 20 (S15). Thereafter, the controller 60 determines whether the vehicle user carries the object according to the portable information of the vehicle user (S16).

When the controller 60 determines that the vehicle user does not carry the object (“No” in S16), it means that there is a possibility that the vehicle user tries to take out the object from the storage space of the rear portion of the vehicle, and at this time, the controller 60 may determine whether the height of the object stored in the storage space is greater than the opening length of the storage space in the up-down direction of the vehicle in a state in which the tailgate is semi-open according to the storage information of the storage space (S17).

When the controller 60 determines that the height of the object stored in the storage space is smaller than the opening length of the storage space in the up-down direction of the vehicle in a state in which the tailgate is semi-open (“NO” in S17), it means that all the objects are stored in the lower half portion of the storage space, and the vehicle user may directly take out the object through the opening of the storage space in a state in which the tailgate is semi-open. At this time, the controller 60 may determine the open state of the tailgate to be used as the semi-open state (S18). In other words, the controller 60 may select a position of the tailgate (e.g., between the semi-open position and the fully open position).

Conversely, when the controller 60 determines that the height of the object stored in the storage space is equal to or greater than the opening length of the storage space in the up-down direction of the vehicle in a state in which the tailgate is semi-open (“YES” in S17), it means that there is a possibility that the object to be taken out by the user may be placed in the upper half portion of the storage space, and it may be difficult for the vehicle user to take out the object through the opening of the storage space in a state in which the tailgate is semi-open. At this time, the controller 60 may determine the open state of the tailgate to be used as the fully open state (S19).

When the controller 60 determines that the vehicle user carries the object (“YES” in S16), as described above, the controller 60 may determine whether the size of the object projected in a specific direction falls within the opening size range of the storage space in a state in which the tailgate is semi-open according to the portable information of the vehicle user (S20). When determining that the size of the object projected in the specific direction does not fall within the opening size range of the storage space in the state in which the tailgate is semi-open (“NO” in S20), the controller 60 may determine the open state of the tailgate to be used as the fully open state (S19). When determining that the size of the object projected in the specific direction falls within the opening size range of the storage space in a state in which the tailgate is semi-open (“YES” in S20), the controller 60 may additionally determine whether the height of the object stored in the storage space is equal to or greater than the opening length of the storage space in the up-down direction of the vehicle in a state in which the tailgate is semi-open according to the storage information of the storage space (S17). When the controller 60 determines that the height of the object stored in the storage space is smaller than the opening length of the storage space in the up-down direction of the vehicle in a state in which the tailgate is semi-open (“NO” in S17), the controller 60 may determine the open state of the tailgate to be used as the semi-open state (S18). When the controller 60 determines that the height of the object stored in the storage space is equal to or greater than the opening length of the storage space in the up-down direction of the vehicle in a state in which the tailgate is semi-open (“YES” in S17), the controller 60 may determine the open state of the tailgate to be used as the fully open state (S19).

After the controller 60 determines the open state of the tailgate to be used (S18 or S19), the controller 60 determines whether the vehicle rear space (e.g., clearance) is sufficient. If the vehicle's rear space is insufficient, an unexpected collision may occur in the process of opening the tailgate.

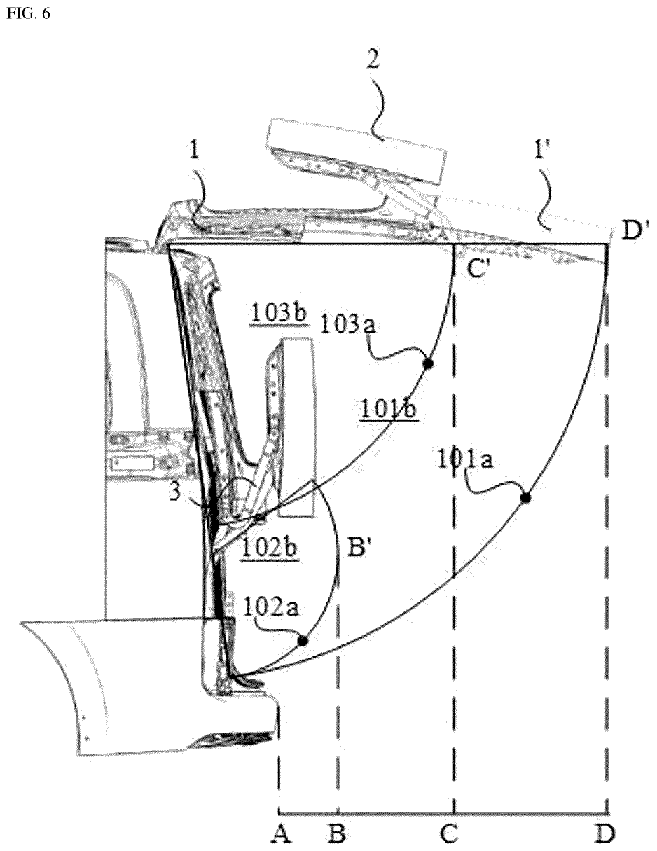

FIG. 6 is a schematic view of rear vehicle clearance required for opening a one-stage tailgate and a two-stage tailgate.

As shown in FIG. 6, the upper end of a general tailgate 1′ is hinged to the upper portion of the rear portion of a vehicle, and thus, in the process of opening the general tailgate 1′, the upper end of the general tailgate 1 may serve as a rotation center, and the lower end of the general tailgate 1′ may move along a curve 101a, that is, the curve 101a may represent a trajectory in which the general tailgate 1′ is opened. The area that goes through in the process of rotating until the general tailgate 1′ is fully opened may be a fan-like area 101b. The point farthest from the rear end of the vehicle in the front-rear direction of the vehicle included in the area 101b is point D′, and the distance from point D′ to the rear end of the vehicle of the vehicle in the front-and-rear direction is the length |AD| of the line segment AD. Accordingly, it is possible to determine whether the vehicle rear space (e.g., clearance) is sufficient to open the general tailgate (1′) using the length |AD| of the line segment AD as a reference value.

Compared to the general tailgate 1′, a two-stage tailgate includes an independent upper tailgate 1 and a lower tailgate 2, but in order to match the opening of the same storage space, the total length of the two-stage tailgate does not change, that is, the length of the upper tailgate 1 and a lower tailgate 2 is equal to the length of the general tailgate 1′.

In the two-stage tailgate, the upper end of the upper tailgate 1 is hinged to the upper portion of the vehicle rear portion, and the lower end of the upper tailgate 1 is connected to the lower tailgate 2 through a rotation mechanism 3, so that the lower tailgate 1 may rotate with respect to the upper tailgate 1 with the rotation mechanism 3 as the rotation center. In the process where the two-stage tailgate is semi-open, the lower tailgate 2 rotates backwards of the upper tailgate along a curve 102a and is placed in a position parallel to the upper tailgate 1, that is, the curve 102a may represent a trajectory where the two-stage tailgate is opened in a semi-open state. The area to be passed in the process of rotating until the lower tailgate 2 is fully opened may be an area 102b similar to a semicircular shape, and a point farthest from the rear end of the vehicle in the front-rear direction of the vehicle (e.g., longitudinal direction) included in the area 102b is a point B′, and a distance from point B′ to the rear end of the vehicle in the front-rear direction (e.g., longitudinal direction) of the vehicle is a length |AB| of a line segment AB. Accordingly, it is possible to determine whether the rear space of the vehicle is sufficient to open the lower tailgate (2) (i.e., the two-stage tailgate is opened to a half-open state) using the length |AB| of the line segment AB as a reference value.

In the process of changing the tailgate from the semi-open state to the fully-open state, the lower tailgate 2 remains stationary with respect to the upper tailgate 1, the upper tailgate 1 is centered on the upper end of the upper tailgate 1, and the lower end of the upper tailgate 1 may move along a curve 103a, that is, the curve 103a may represent a trajectory in which the two-stage tailgate is opened to the fully-open state. The area that goes through in the process of rotating until the upper tailgate 1 is fully opened may be a fan-like area 103b. The point farthest from the rear end of the vehicle in the front-rear direction of the vehicle included in the region 103b is point C′, and the distance from point C′ to the rear end of the vehicle is the length |AC| of the line segment AC. Accordingly, it is possible to determine whether the rear space of the vehicle is sufficient to open the upper tailgate 1 (i.e., the two-stage tailgate is opened to a fully open state) using the length |AC| of the line segment AC as a reference value.

As described above, the length |AD| of the line segment AD is greater than the length |AC| of the line segment AC, and the length |AC| of the line segment AC is greater than the length |AB| of the line segment AB. In a specific example, a length relationships |AB|, |AC|, and |AD| between the line segment AB, the line segment AC, and the line segment AD may be represented as follows:

$$\vert AB \vert = \frac{1}{4} \vert AD \vert = \frac{1}{2} \vert AC \vert$$

In other words, compared to the general tailgate 1′, the two-stage tailgate may reduce the vehicle rear space required when opening the tailgate (e.g., clearance), but in a two-stage tailgate that the system of the present disclosure must control, the lengths |AB| and |AC| is merely representative of the vehicle rear space required when opening the two-stage tailgate in a corresponding state, so that when determining whether the vehicle rear space is sufficient using the lengths |AB| and |AC| as the reference value, the vehicle rear space necessary for the vehicle user to stand is overlooked.

In this specification, whether the vehicle rear space is sufficient means whether the length of the vehicle rear space in the front-rear direction of the vehicle is sufficient regardless of whether the length in the left-right direction of the vehicle or the length in the up-down direction of the vehicle in the rear space is sufficient.

In parallel to (e.g., concurrently with) the step S15, the controller 60 may acquire the height of the vehicle user based on the sensor data of the first sensor (S21), that is, when the controller recognizes the vehicle front image or the vehicle rear image, the controller may acquire the height of the vehicle user in addition to the portable information of the user. After determining the open state of the tailgate to be used (S18 or S19), the controller 60 may calculate a reference value for determining whether the vehicle rear space is sufficient according to the acquired height information of the vehicle user and the determined open state of the tailgate to be used (S22).

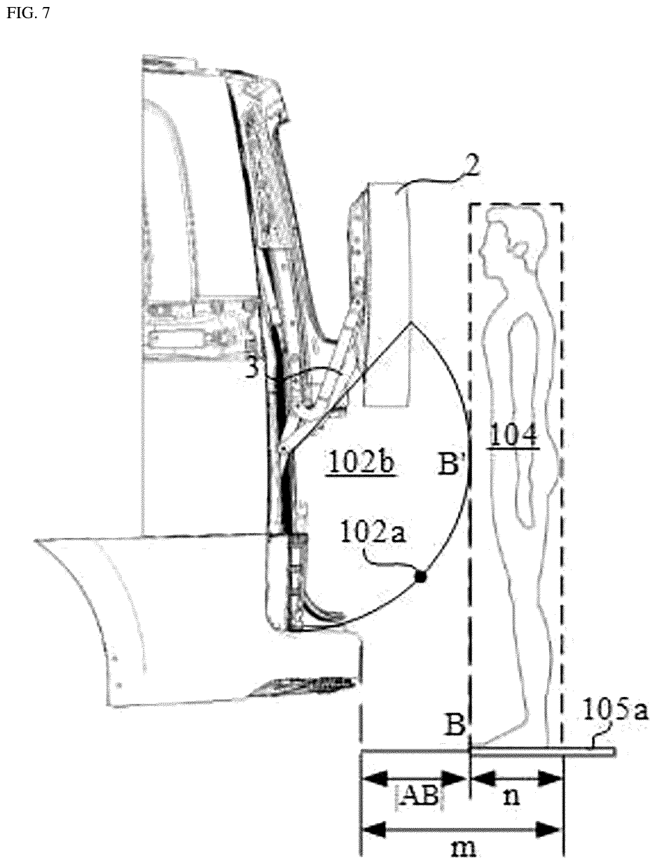

FIG. 7 is a schematic diagram of calculating a reference value when an example two-stage tailgate is opened in a semi-open state. As shown in FIG. 7, when a two-stage tailgate is opened in a semi-open state, the height of point B′ is about 90 cm to 110 cm, so that the height of the vehicle user is always higher than the height of point B′. In order to prevent a collision with the vehicle user when the tailgate is opened, the vehicle user has no choice but to stand at a position farther from the rear end of the vehicle than point B′. When a block 104 representing the range of the vehicle user has an intersection point B′ with the curve 102a representing exactly the opening trajectory of the tailgate, it indicates that the vehicle user may be in the closest position to the rear end of the vehicle. At this time, the controller 60 may calculate the reference value through the following formula:

$$m = \vert AB \vert + n$$

wherein: m is the reference value for determining whether the vehicle rear space is sufficient, and |AB| is the maximum distance of the opening trajectory of the tailgate to the rear end of the vehicle in the front-rear direction of the vehicle, and n is a preset side length of the vehicle user.

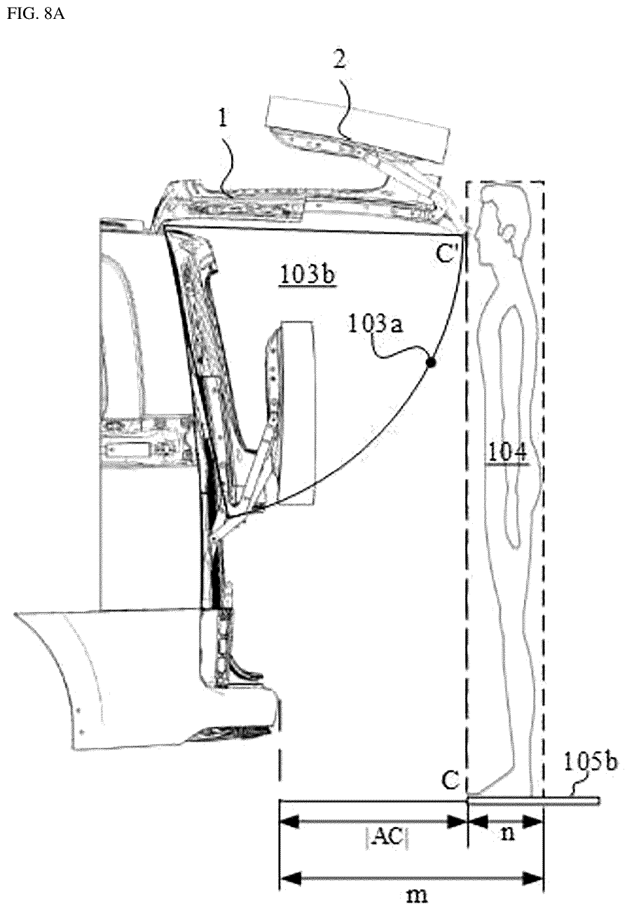

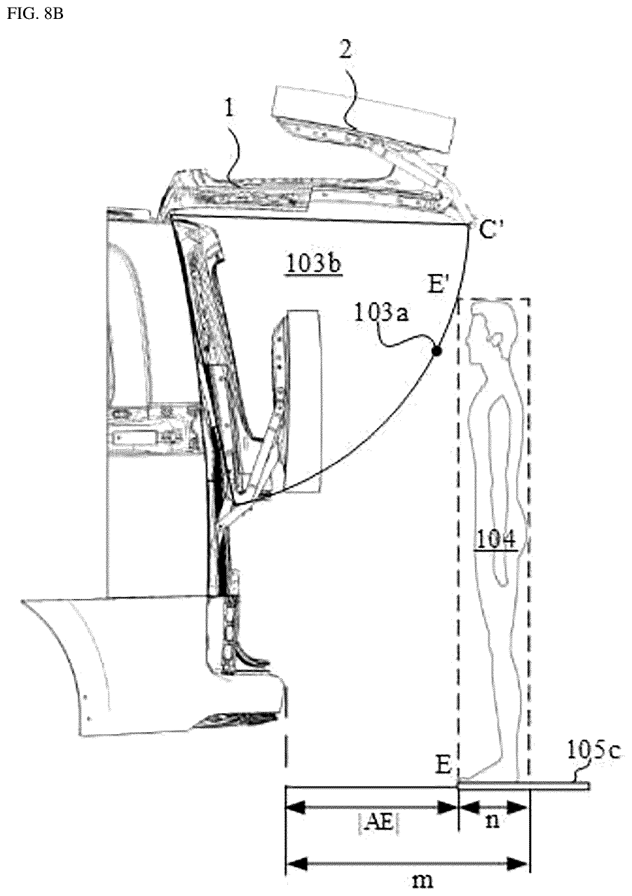

FIGS. 8A and 8B are schematic diagrams for calculating a reference value when an example two-stage tailgate is opened in a fully open state. Referring to FIG. 8A and FIG. 8B, since the height of point C′ is about 160 cm to 180 cm, the height of the vehicle user may be greater than or equal to the height of the highest point C′ of the curve 103a and may be less than or equal to.

As shown in FIG. 8A, if the vehicle user's height is not lower than point C′, which is the highest point of the curve 103a, the vehicle user must stand outside the two-stage tailgate, i.e., at a position farther from the rear end of the vehicle than point C′, otherwise a collision with the vehicle user may occur when opening the tailgate. If the block 104 representing the vehicle user range has an intersection point C′ with the curve 103a representing exactly the opening trajectory of the tailgate, it represents the position where the vehicle user may be closest to the rear end of the vehicle.

As shown in FIG. 8B, if the height of the vehicle user is lower than point C′, which is the highest point of the curve 103a, a part of the vehicle user may stand under the two-stage tailgate, specifically, the block 104 for indicating the range of the vehicle user may have one intersection point E′ with the curve 103a for indicating exactly the tailgate opening trajectory, so that the distance from point E′ to the rear end of the vehicle in the front-rear direction of the vehicle may be indicated by |AE|, which is the length of the line segment AE.

In summary, when the open state of the tailgate to be used is the fully open state, the controller 60 may calculate a reference value through the following formula:

$$m = \{ \begin{matrix}\vert AC \vert + n , & h \geq {H}_{c} \\ \vert AE \vert + n , & h < {H}_{c}\end{matrix}$$

wherein: m is the reference value for determining whether the vehicle rear space is sufficient, |AC| is the maximum distance of the opening trajectory of the tailgate to the rear end of the vehicle in the front-rear direction of the vehicle, nis the preset side length of the vehicle user, and h is the height of the vehicle user, H_{C} is the distance from a trajectory point (that is, point C′) farthest from the rear end of the vehicle in the front-rear direction of the vehicle to the ground in the up-down direction of the vehicle among the opening trajectories of the tailgate, and |AE| is the distance from the trajectory point (that is, point E′) corresponding to the height of the vehicle user in the front-rear direction of the vehicle to the rear end of the vehicle in the opening trajectory of the tailgate.

When determining that the vehicle user is carrying an object, the value m, which is the reference value, may further add the length of the object carried by the vehicle user in any direction (for example, the length of the carrier), thereby providing the vehicle rear space required for the object carried by the vehicle user.

As illustrated in FIG. 5B, after the controller 60 calculates a reference value S22 for determining whether the vehicle rear space is sufficient, the controller 60 may execute an operation for determining whether the vehicle rear space is sufficient.

Specifically, returning to FIG. 2, the tailgate control system may further include a third sensor 30 provided in the vehicle rear portion and configured to acquire sensor data of the vehicle rear space. Specifically, the third sensor 30 may be a backward radar installed in the rear bumper, and the backward radar may transmit the sensor data (for example, a voltage signal or a current signal) of the acquired vehicle rear space to the controller 60. The controller 60 may acquire information on the vehicle rear space according to the sensor data acquired by the third sensor 30 (S23).

The information on the vehicle rear space means the length of the vehicle rear space in the front-rear direction of the vehicle.

Therefore, the controller may compare the acquired length of the vehicle rear space in the front-rear direction of the vehicle with the calculated reference value to determine whether the length of the vehicle's rear space in the front and rear direction of the vehicle is greater than the reference value (S24). When the length of the vehicle rear space in the front-rear direction of the vehicle is greater than the reference value (“YES” in S24), the controller may determine that the vehicle rear space is sufficient. When the length of the vehicle rear space in the front-rear direction of the vehicle is equal to or less than the reference value (“NO” in S24), the controller may determine that the vehicle rear space is insufficient.

When the controller determines that the vehicle rear space is insufficient, the controller may be configured to generate a notification for asking whether the vehicle is moving, and the controller may control a speaker installed in the vehicle to output the generated notification (S25). For example, the speaker may output a voice saying, “Do you want to move the vehicle?”

In response, the vehicle user may input a control command for moving the vehicle. The vehicle user may input a control command for moving the vehicle while the vehicle user remains stationary near the tailgate. In other words, the controller 60 may determine whether the vehicle user maintains a predetermined distance (for example, 0.5 m, 1 m, or the like) from the tailgate within a reference time (for example, 3 s) according to the user terminal carried by the vehicle user (S26). When the user terminal maintains a predetermined distance from the tailgate within the reference time (“YES” in S26), it means that the vehicle user maintains a stationary state near the tailgate, and accordingly, the controller 60 may determine that the vehicle user has input a control command for moving the vehicle. Conversely, when the user terminal does not maintain the predetermined distance from the tailgate within the reference time (“NO” in S26), the controller 60 may determine that the vehicle user has not input the control command of the vehicle. The vehicle user may press an approval button or a confirmation button on the vehicle movement of the user terminal (for example, a smartphone), so that the user terminal may transmit a button press signal for moving the vehicle to the controller 60, and when receiving the button press signal for the vehicle movement, the controller 60 may determine that the vehicle user has input a control command for the vehicle movement.

When the user terminal maintains a predetermined distance from the tailgate within the reference time (“YES” in S26), that is, when the vehicle user inputs a control command for moving the vehicle, the controller 60 may activate an automatic parking function of an Advanced Driver Assistance System (ADAS) to automatically move the vehicle so that the length of the vehicle rear space in the front-rear direction of the vehicle is appropriately increased (S27).

After the length of the vehicle rear space in the front-rear direction of the vehicle is appropriately increased, the operation of the controller may return to the step S24, that is, the controller 60 may compare and determine whether the length of the vehicle rear space in the front-rear direction of the vehicle after being increased again is equal to or greater than the reference value (S24), and the controller 60 determines that the vehicle rear space is sufficient when the length of the vehicle rear space in the front-rear direction of the vehicle after being increased is equal to or greater than the reference value (“YES” in S24).

However, when the user terminal does not maintain a predetermined distance from the tailgate within the reference time (“NO” in S26), that is, when the vehicle user does not input a control command for moving the vehicle, the controller 60 may be configured to generate a notification that the vehicle rear space is insufficient, and the controller 60 may also control to output the generated notification through a speaker installed in the vehicle (S28). For example, the speaker may output a voice saying, “the rear space of the vehicle is insufficient”.

Returning to FIGS. 7, 8A, and 8B, in the process of the controller 60 calculating the reference value, the controller 60 analyzes the positional relationship between the block 104 for indicating the range of the vehicle user and the curves 102a, 103a for indicating the opening trajectory (e.g., movement trajectory) of the tailgate to prevent a collision with the vehicle user when the tailgate is opened. However, if the analysis result is not shown to the vehicle user, the vehicle user does not know where to stand and a collision may still occur.

Specifically, returning to FIG. 2, the tailgate control system may further include a projection lamp 50, and the projection lamp 50 is installed on a rear portion (specifically, a bottom portion of the rear portion) of the vehicle, and is configured to project light onto a ground of the rear of the vehicle to indicate a position where the vehicle user is standing.

If the controller 60 determines that the length of the vehicle rear space in the front-rear direction of the vehicle is greater than the reference value, that is, after determining that the vehicle rear space is sufficient (“YES” in S24), and before the controller 60 controls the opening of the tailgate (S32), the controller 60 may control the projection lamp 50 to project light to indicate a position where the vehicle user is safely standing (S29).

Referring to FIGS. 7, 8A, and 8B, the controller 60 may control the projection lamp 50 to project light to a location where the illustrated vehicle user is standing.

In other words, when the open state of the tailgate to be used is the semi-open state, the controller 60 controls the projection position of the projection lamp so that the projection area formed on the ground of the vehicle rear portion satisfies the following formula:

$$P = \vert AB \vert ,$$

wherein: p is the minimum distance of the boundary of the projection area to the rear end of the vehicle in the front-rear direction of the vehicle (e.g., p may be the minimum longitudinal distance between the rear end of the vehicle and the projection area), and |AB| is the maximum distance of the opening trajectory of the tailgate to the rear end of the vehicle in the front-rear direction of the vehicle (e.g., |AB| may be the maximum longitudinal distance between the rear end of the vehicle and a movement trajectory of the rear gate between a closed position and the semi-open position).

That is, the point closest to the rear end of the vehicle in the front-rear direction of the vehicle included in the projection area is point B, and for example, the projection area may correspond to an area 105a.

When the open state of the tailgate to be used is the fully open state, the controller 60 controls the projection position of the projection lamp so that the projection area formed on the ground of the rear portion of the vehicle satisfies the following formula:

$$p = \{ \begin{matrix}\vert AC \vert , & h \geq {H}_{C} \\ \vert AE \vert , & h < {H}_{C}\end{matrix}$$

wherein: p is the minimum distance of the boundary of the projection area to the rear end of the vehicle in the front-rear direction of the vehicle (e.g., p may be the minimum longitudinal distance between the rear end of the vehicle and the projection area), and |AC| is the maximum distance of the opening trajectory of the tailgate to the rear end of the vehicle in the front-rear direction of the vehicle (e.g., |AC| may be the maximum longitudinal distance between the rear end of the vehicle and a movement trajectory of the rear gate between the closed position and the fully open position), and h is the height of the vehicle user, H_{C} is the distance from a trajectory point farthest from the rear end of the vehicle in the front-rear direction of the vehicle to the ground in the up-down direction of the vehicle in an opening trajectory of the tailgate (e.g., _{HC} may be the minimum height of the rear gate at the fully open position), and |AE| is the distance from the trajectory point corresponding to the height of the vehicle user in the front-rear direction of the vehicle in the opening trajectory of the tailgate to the rear end of the vehicle (e.g., |AE| may be the longitudinal distance between the rear end of the vehicle and a point, on the movement trajectory of the rear gate between the closed position and the fully open position, that corresponds to the height of the vehicle user).

That is, when the height of the vehicle user is not lower than point C′, the point is closest to the rear end of the vehicle in the front-rear direction of the vehicle included in the projection area is point C, and for example, the projection area may correspond to the area 105b. That is, when the height of the vehicle user is lower than point C′, which is the highest point of the curve 103a, the point closest to the rear end of the vehicle in the front-rear direction of the vehicle included in the projection area is point E, and for example, the projection area may correspond to the area 105c.

When the point closest to the rear end of the vehicle in the front-rear direction of the vehicle included in the projection area is determined, the point furthest from the rear end of the vehicle in the front-rear direction of the vehicle included in the projection area may be represented as follows:

$$q = p + 2 r ,$$

where q is the maximum distance of the boundary of the projection area to the rear end of the vehicle in the front-rear direction of the vehicle, and 2r is the length of the projection area in the front-rear direction of the vehicle. If the projection area is circular, r may represent the radial length of the projection area.

After the controller 60 controls the projection lamp 50 to project light (S29), and before the controller 60 controls opening of the tailgate (S32), the controller 60 may acquire the position of the vehicle user according to the sensor data acquired by the third sensor (that is, the sensor data of the vehicle rear space) (S30), and determine whether the acquired position of the vehicle user is in the projection area or farther from the rear end of the vehicle than the projection area (S31).

When determining that the position of the vehicle user is farther from the projection area or the rear end of the vehicle than the projection area (“YES” in S31), since it indicates that the vehicle user is already standing in the safe position, at this time, the controller 60 may control the opening of the tailgate (S32), and specifically, the controller 60 controls the tailgate to open in the determined use state.

After the tailgate is opened, if the vehicle user does not satisfy the open state of the tailgate, the vehicle user may manually press the fully open button or the semi-open button installed on the tailgate to adjust the open state of a tailgate. After the vehicle user readjusts the open state of the tailgate, the vehicle user may put the carried object into the storage space or take the object out of the storage space.

After the vehicle user puts the object in or takes it out, the vehicle user may input a control command for closing the tailgate. As described above, for example, the control command for closing the tailgate may be a hand gesture operation. In reference to FIG. 2, the tailgate control system may further include a fourth sensor 40, and the fourth sensor 40 is installed in the lower tailgate 2 (the lower half portion of the storage space is configured to be opened), and is configured to acquire sensor data of the rear of the tailgate in a state in which the tailgate is semi-open. For example, the fourth sensor 40 may be a camera, and the camera may transmit the acquired tailgate rear image to the controller 60. The vehicle user may make a hand gesture (e.g., OK gesture) toward the camera installed on the lower tailgate 2 to indicate that the operation of putting or taking out an object has been completed.

In a state in which the tailgate is semi-open, the lower tailgate 2 moves to the rear of the upper tailgate 1, so considering that the lower tailgate 2 may block the view of the rear camera 10a, instead of using the rear camera 10a, the fourth sensor 40 is additionally installed to acquire sensor data at the rear of the tailgate.

However, in a state in which the tailgate is fully open, the lower tailgate 2 and the upper tailgate 1 are lifted together to a position parallel to the ground, so that the fourth sensor 40 faces upward of the vehicle, so that a hand gesture taken by the vehicle user may not be acquired. In this case, the vehicle user may make a hand gesture toward the rear camera 10a.

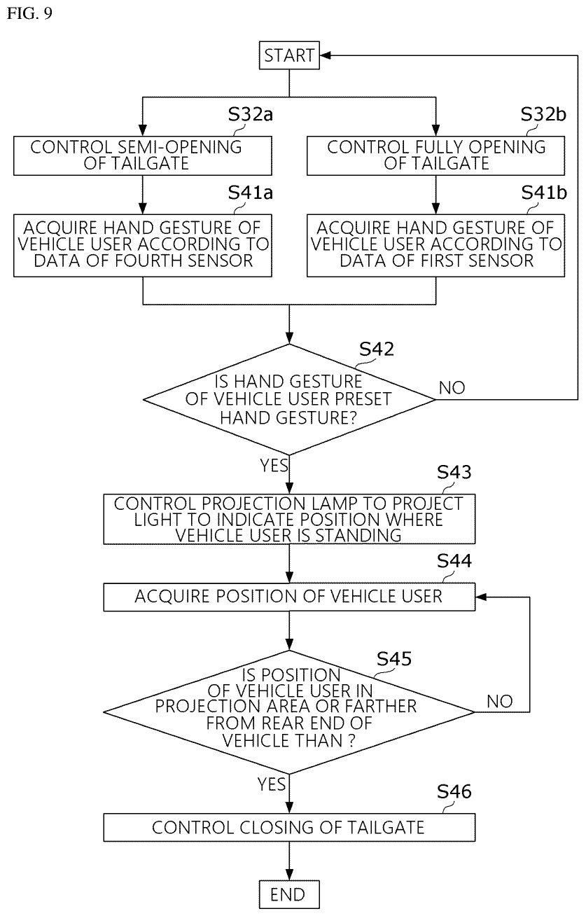

FIG. 9 is an operational flow diagram of an example controlling method for closing a tailgate. As shown in FIG. 9, after the controller 60 controls the tailgate to be opened in the semi-open state (S32a), the controller 60 may acquire a hand gesture of the vehicle user according to the sensor data acquired by the fourth sensor 40 (S41a). After the controller 60 controls the tailgate to be opened in the fully open state (S32b), the controller 60 may acquire a hand gesture of the vehicle user according to the sensor data acquired by the first sensor 10 (specifically, the rear camera 10a) (S41b).

The controller 60 determines whether the acquired hand gesture of the vehicle user is a hand gesture for closing the preset tailgate (S42). When determining that the hand gesture of the vehicle user is the hand gesture for closing the preset tailgate (“YES” in S42), the controller 60 may determine that the vehicle user has input a control command for closing the tailgate.

The control instruction for closing the tailgate may be a button press signal or a voice signal, that is, the user may press the tailgate button of the user terminal (for example, the fob key) or say, “close the tailgate.”

If the hand gesture of the vehicle user is a hand gesture for closing the preset tailgate (“YES” in S42), that is, when the vehicle user inputs a control command for closing the tailgate, the controller 60 may control the projection lamp 50 to project light again to indicate a position where the vehicle user is safely standing so that a collision with the vehicle user does not occur when the tailgate is closed (S43). Further, since the tailgate opening trajectory and the tailgate closing trajectory are the same, the projection position of the projection lamp 50 controlled by the controller 60 in the step S29 is the same as the projection position of the projection lamp 50 controlled in the step 43 by the controller 60.

Similarly, after the controller 60 controls the projection lamp 50 to project light (S43), and before the controller 60 controls closing of the tailgate (S46), the controller 60 may acquire the position of the vehicle user according to the sensor data acquired by the third sensor 30 (that is, the sensor data of the vehicle rear space) (S44), and determine whether the acquired position of the vehicle users is in the projection area or farther from the rear end of the vehicle than the projection area (S45). When determining that the position where the vehicle user is standing is farther from the rear end of the vehicle than the projection area or the projection area (“YES” in S45), it indicates that the vehicle user is already standing in the safe position, and at this time, the controller 60 may control closing of the tailgate (S46).

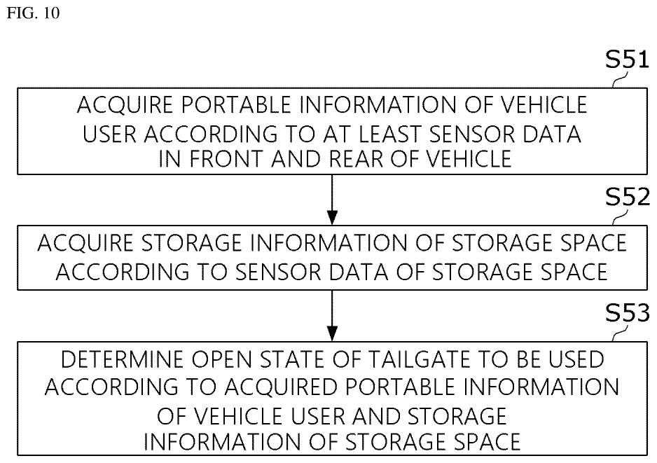

A method of controlling a tailgate is provided. FIG. 10 is a flowchart of an example tailgate control method. As shown in FIG. 10, the method for tailgate control may include: a step of acquiring portable information of a vehicle user according to at least sensor data in front and rear of the vehicle (e.g., an environment around the vehicle) (S51); a step of acquiring storage information of a storage space (e.g., a trunk, a storage compartment, a cargo hold, etc.) according to sensor data of the storage space (S52); and a step of determining an open state of a tailgate to be used according to the acquired portable information of the vehicle user and the acquired storage information of the storage space.

The step (S53) of determining an open state of a tailgate to be used according to the acquired portable information of the vehicle user and the acquired storage information of the storage space includes: a step of acquiring an opening size including an opening length in an up-down direction of the vehicle and an opening length in a left-right direction of the vehicle in the storage space in a state in which the tailgate is semi-open; a step of determining whether the vehicle user is carrying an object according to the portable information of the vehicle user; a step of determining, according to the portable information of the vehicle user, whether a size of the object projected in a specific direction falls within an opening size range of the storage space in a state in which the tailgate is semi-open when determining that the vehicle user carries the object; a step of determining whether the height of the object stored in the storage space is equal to or greater than the opening length of the storage space in the up-down direction of the vehicle in the state in which the tailgate is semi-open, according to the storage information of the storage space, when determining that the size of the object projected in a specific direction falls within the opening size range of the storage space in a state in which the tailgate is semi-open, or when determining that the vehicle user does not carry the object; a step of determining the open state of the tailgate to be used as a fully open state when determining that a height of an object stored in the storage space is equal to or greater than an opening length of the storage space in the up-down direction of the vehicle in a state in which the tailgate is semi-open; a step of determining the open state of the tailgate to be used as the semi-open state when determining that the height of the object stored in the storage space is smaller than the opening length of the storage space in the up-down direction of the vehicle in a state in which the tailgate is semi-open; a step of determining the open state of the tailgate to be used as the fully open state when determining that the size of the object projected in the specific direction does not fall within the opening size range of the storage space in which the tailgate is in the semi-open state.

In order to finally open the tailgate in a corresponding state, it may be further necessary to determine whether the vehicle user has input a control command for opening the tailgate. Accordingly, the method for tailgate control may further include a step of determining whether the vehicle user inputs a control command for opening the tailgate before determining the open state of the tailgate to be used (S53); and a step of determining the open state of the tailgate to use when determining that the vehicle user has input a control command for opening the tailgate.

It is also necessary to further determine whether the vehicle rear space is sufficient in order to finally open the tailgate in a corresponding state. Therefore, the method for tailgate control includes: a step of acquiring a height of the vehicle user according to at least vehicle front and rear sensor data; and a step of calculating after determining the open state of the tailgate to be used, a reference value for determining whether the rear space of the vehicle is sufficient according to the acquired height of the vehicle user and the determined open state of the tailgate to be used (S53).

Specifically, the step of calculating the reference value may include a step of determining (e.g., calculating) when the open state of the tailgate to be used is the semi-open state, the reference value through the following formula:

$$m = \vert AB \vert + n ,$$

wherein: m is the reference value, |AB| is the maximum distance of the opening trajectory of the tailgate to the rear end of the vehicle in the front-rear direction of the vehicle, and n is the preset side length of the vehicle user.

When the open state of the tailgate to be used is the fully open state, it may include a step of calculating a reference value through the following formula:

$$m = \{ \begin{matrix}\vert AC \vert + n , & h \geq {H}_{C} \\ \vert AE \vert + n , & h < {H}_{C}\end{matrix}$$

wherein: m is the reference value, |AC| is the maximum distance of the opening trajectory of the tailgate to the rear end of the vehicle in the front-rear direction of the vehicle, n is the preset side length of the vehicle user, and h is the height of the vehicle user. H_{C} is the distance from a trajectory point farthest from the rear end of the vehicle in the front-rear direction of the vehicle to the ground in the up-down direction of the vehicle in an opening trajectory of the tailgate, and |AE| is the distance from the trajectory point corresponding to the height of the vehicle user in the front-rear direction of the vehicle to the rear end of the vehicle in the opening trajectory of the tailgate.

After calculating the reference value, the method for tailgate control may include a step of acquiring a length of the vehicle rear space in the front-rear direction of the vehicle according to the sensor data of the vehicle rear space; a step of comparing the acquired length of the vehicle rear space in the front-rear direction of the vehicle with the calculated reference value to determine whether the length of the vehicle rear space in the front-rear direction of the vehicle is greater than the reference value; a step of determining that the vehicle rear space is sufficient; when the length of the vehicle rear space in the front-rear direction of the vehicle is less than or equal to the reference value when a length of the vehicle rear space in the front-rear direction of the vehicle is greater than a reference value; and a step of determining that the vehicle rear space is insufficient when a length of the vehicle rear space in the front-rear direction of the vehicle is less than or equal to the reference value.

It may generate and output a notification asking whether the vehicle is moving if it is determined that the vehicle rear space is insufficient; determine whether a vehicle user inputs a control command for moving the vehicle; activate the automatic parking function of the ADAS to move the vehicle until a rear space of the vehicle becomes sufficient if determining that the vehicle user has input a control command for moving the vehicle; and control the opening of the tailgate after determining that the vehicle rear space is sufficient.

The above-mentioned specific step of determining whether the vehicle user inputs a control command for movement of the tailgate or a control command for opening of the tailgate includes: a step of determining whether the vehicle user maintains a predetermined distance from the tailgate within a reference time according to a user terminal carried by the vehicle user; and a step of determining that the vehicle user has input a control command for moving the vehicle or a control command for opening the tailgate when the vehicle user maintains the predetermined distance from the tailgate within the reference time. That is, it indicates that the vehicle user inputs a control command for opening the tailgate or a control command for moving the vehicle by maintaining the vehicle user stationary in a standing position near the tailgate.

In addition to controlling the opening of the tailgate, the method for controlling the tailgate may also control the closing of the tailgate. Accordingly, the method for tailgate control includes: a step of determining whether the vehicle user has input a control command for closing the tailgate after controlling the opening of the tailgate; and a step of controlling the closing of the tailgate when determining that the vehicle user has input a control command for closing the tailgate.

Specifically, the step of determining whether the vehicle user has input a control command for closing the tailgate includes: a step of acquiring, after controlling the tailgate to open in a semi-open state, a hand gesture of a vehicle user according to sensor data of the rear of the tailgate in a state in which the tailgate is semi-open; and a step of acquiring, after controlling the tailgate to open to a fully open state, a hand gesture of the vehicle user according to the sensor data of the rear of the vehicle. Then it may include a step of determining whether the acquired hand gesture of the vehicle user is a hand gesture for closing the preset tailgate; a step of determining, when the gesture of the vehicle user is a hand gesture for closing the preset tailgate, that the vehicle user has input a control command for closing the tailgate. For example, the vehicle user's OK gesture indicates that the vehicle user has input a control command to close the tailgate.

In addition, the method for tailgate control may further include: a step of controlling the projection lamp to project light onto the ground of the rear of the vehicle to indicate the position where the user is standing, before determining that the rear space of the vehicle is sufficient to control the opening of the tailgate, or before determining that the vehicle user has input a control command for closing the tailgate to control the closing of the tailgate.

Specifically, the step of controlling the projection lamp may include: a step of controlling, when the open state of the tailgate to be used is the semi-open state, the projection position of the projection lamp such that the projection area formed on the ground of the vehicle rear portion satisfies the following formula:

$$p = \vert AB \vert ,$$

wherein: p is the minimum distance of the boundary of the projection area to the rear end of the vehicle in the front-rear direction of the vehicle, |AB| is the maximum distance of the opening trajectory of the tailgate to the rear end of the vehicle in the front-rear direction of the vehicle.

It may include a step of controlling, when the open state of the tailgate is the fully open state, the projection position of the projection lamp such that the projection area formed on the ground of the rear portion of the vehicle satisfies the following formula:

$$p = \{ \begin{matrix}\vert AC \vert , & h \geq {H}_{C} \\ \vert AE \vert , & h < {H}_{C}\end{matrix}$$

wherein: p is the minimum distance of the boundary of the projection area to the rear end of the vehicle in the front-rear direction of the vehicle, |AC| is the maximum distance of the opening trajectory of the tailgate to the rear end of the vehicle in the front-rear direction of the vehicle, and h is the height of the vehicle user, H_{C} is the distance from a trajectory point farthest from the rear end of the vehicle in the front-rear direction of the vehicle to the ground in the up-down direction of the vehicle in an opening trajectory of the tailgate, and |AE| is the distance from the trajectory point corresponding to the height of the vehicle user in the front-rear direction of the vehicle to the rear end of the vehicle in the opening trajectory of the tailgate.

It may include a step of acquiring, before controlling opening or closing of a tailgate after the projection lamp projects light, a position of a vehicle user according to sensor data of a vehicle rear space; a step of determining whether the acquired position of the vehicle user is in the projection area or further away from the rear end of the vehicle than the projection area; and a step of controlling, when determining that the position at which the vehicle user is standing is in the projection area or further away from the rear end of the vehicle than the projection area, the opening or closing of the tailgate.

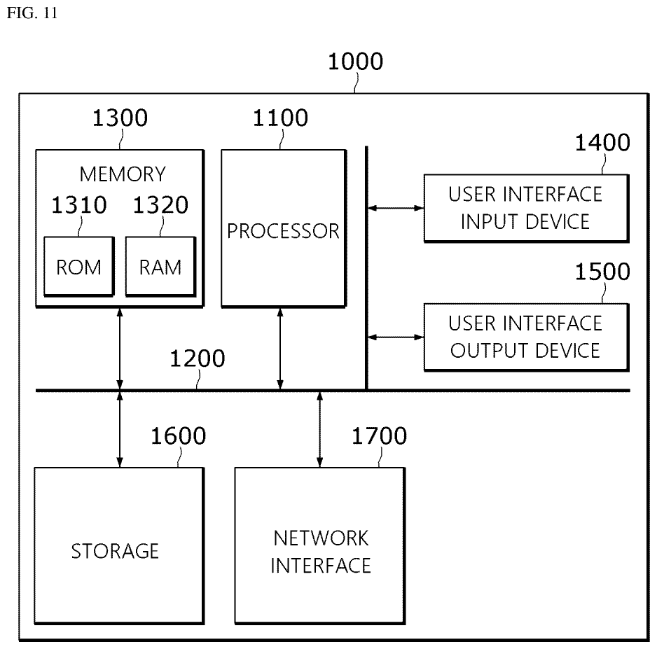

FIG. 11 shows an example computing system (e.g., a computing device of a vehicle or any other apparatus). One or more controllers, processors, etc. described herein (e.g., the first sensor 10, the second sensor 20, the controller 60, etc.) may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable read-only memory (EPROM), an electrically erasable and programmable read-only memory (EEPROM), a register, a hard disk drive, a removable disc, or a compact disc read-only memory (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one or more example implementations of the present disclosure, According to the present disclosure, there is provided a system for tailgate control having a fully open state that fully opens the storage space of the rear portion of the vehicle or a semi-open state that opens a lower half portion of the storage space of the rear portion of the vehicle, wherein the system includes a first sensor installed on at least a front portion and a rear portion of a vehicle, and configured to acquire sensor data of at least sensor data in front and rear of the vehicle; a second sensor installed in a storage space of the rear portion of the vehicle and configured to acquire sensor data of the storage space; and a controller configured to acquire portable information related to an object of a vehicle user according to the sensor data acquired by the first sensor; acquire storage information of the storage space according to the sensor data acquired by the second sensor; and determine the open state of the tailgate to be used according to the acquired portable information of the vehicle user and the acquired storage information of the storage space.

The controller is configured to acquire an opening size of the storage space including an opening length in an up-down direction of the vehicle and an opening length in a left-right direction of the vehicle in a state in which the tailgate is semi-open; determine whether the vehicle user carries the object according to the portable information of the vehicle user; determine, when determining that the vehicle user carries the object, whether the size of the object projected in a specific direction falls within an opening size range of the storage space in a state in which the tailgate is semi-open according to the portable information of the vehicle user; determine, when determining that the size of the object projected in a specific direction falls within an opening size range of the storage space a state in which the tailgate is semi-open, or when determining that the vehicle user does not carry the object, whether the height of the object stored in the storage space is equal to or greater than the opening length of the storage space in the up-down direction of the vehicle in a state in which the tailgate is semi-open according to the storage information of the storage space; determine, when determining that the height of the object stored in the storage space is equal to or greater than the opening length of the storage space in the up-down direction of the vehicle in a state in which the tailgate is semi-open, the open state of the tailgate to be used as the fully open state; determine, when determining that the height of the object stored in the storage space is smaller than the opening length of the storage space in the up-down direction of the vehicle in a state in which the tailgate is semi-open, the open state of the tailgate to be used as the semi-open state, and determine, when determining that the size of the object projected in a specific direction does not fall within an opening size range of the storage space a state in which the tailgate is semi-open, the open state of the tailgate to be used as a fully open state.

The controller is configured to acquire a height of the vehicle user according to the sensor data acquired by the first sensor; and calculate, after determining the open state of the tailgate to be used, a reference value for determining whether a vehicle rear space is sufficient according to the acquired height of the vehicle user and the determined open state of the tailgate to be used.

The controller, when the open state of the tailgate to be used is the semi-open state, calculates a reference value using the following formula:

$$m = \vert AB \vert + n ,$$

wherein m is the reference value, |AB| is the maximum distance of the opening trajectory of the tailgate to the rear end of the vehicle in the front-rear direction, and n is the preset side length of the vehicle user; and
when the opening state of the tailgate to be used is a fully open state, it may be configured to calculate a reference value using the following formula:

$$m = \{ \begin{matrix}\vert AC \vert + n , & h \geq Hc \\ \vert AE \vert + n , & h < Hc\end{matrix}$$

wherein m is the reference value, |AC| is the maximum distance of the opening trajectory of the tailgate to the rear end of the vehicle in the front-rear direction of the vehicle, n is the preset side length of the vehicle user, h is the height of the vehicle user, Hc is the distance from the farthest trajectory point from the rear end of the vehicle in the front-rear direction in the tailgate opening trajectory to the ground in the up-down direction of the vehicle, and JAEL, is the distance from a trajectory point corresponding to the height of the vehicle user in the front-rear direction of the vehicle in the opening trajectory of the tailgate to the rear end of the vehicle.

The system for tailgate control may further include a third sensor installed on a rear portion of the vehicle and configured to acquire sensor data of the vehicle rear space; and the controller may be configured to acquire the length of the vehicle rear space in the front-rear direction of the vehicle according to the sensor data acquired by the third sensor; compare the acquired length of the vehicle rear space in the front-rear direction of the vehicle with the calculated reference value to determine whether the length of the vehicle rear space in the front-rear direction of the vehicle is greater than the reference value; determine that the vehicle rear space is sufficient when the length of the vehicle rear space in the front-rear direction of the vehicle is greater than the reference value; and determine that the vehicle rear space is insufficient when the length of the vehicle rear space in the front-rear direction of the vehicle is less than or equal to the reference value.

The controller may be configured to: generate and output, when determining that the vehicle rear space is insufficient, a notification for asking whether the vehicle is moving; determine whether the vehicle user inputs a control command for moving the vehicle; activate, when determining that the vehicle user inputs the control command for moving the vehicle, an automatic parking function of an advanced driving assistance system to move the vehicle until the vehicle rear space becomes sufficient; and control the opening of the tailgate after determining that the vehicle rear space is sufficient.

The controller may be configured to determine, before determining the open state of the tailgate to be used, whether the vehicle user inputs a control command for opening the tailgate; and determine, when determining that the vehicle user inputs the control command for opening the tailgate, the open state of the tailgate to be used.

The controller may be configured to determine whether the vehicle user maintains a predetermined distance from the tailgate within a reference time according to a user terminal carried by the vehicle user; and determine, when the vehicle user maintains the predetermined distance from the tailgate within the reference time, that the vehicle user inputs a control command for moving the vehicle or a control command for opening the tailgate.

The controller is configured to determine, after controlling the opening of the tailgate, whether the vehicle user inputs a control command for closing the tailgate; and control, when determining that the vehicle user inputs the control command for closing the tailgate, the closing of the tailgate.

The system for tailgate control may further include a fourth sensor installed in a lower tailgate that is a structure that opens a lower half portion of the storage space, and configured to acquire sensor data of the rear of the tailgate in a state in which the tailgate is semi-open; and the controller may be configured to: acquire, after controlling the tailgate to be opened in a semi-open state, a hand gesture of the vehicle user according to the sensor data acquired by the fourth sensor; acquire, after controlling the tailgate to be opened in a fully open state, a hand gesture of the vehicle user according to the sensor data acquired by the first sensor; determine whether the acquired hand gesture of the vehicle user is a hand gesture for closing the preset tailgate; and determine, when the hand gesture of the vehicle user is a gesture for closing the preset tailgate, that the vehicle user inputs a control command for closing the tailgate.

The system for tailgate control may further include a projection lamp installed on a rear portion of the vehicle, and configured to project light onto a ground surface at the rear of the vehicle to indicate a position where the user is standing; and the controller may be configured to: cause the projection lamp to project light before controlling the opening of the tailgate when determining that the rear space of the vehicle is sufficient, or before controlling the closing of the tailgate when determining that the vehicle user inputs a control command for closing the tailgate.

The controller may be configured to:
control, when the open state of the tailgate to be used is the semi-open state, the projection position of the projection lamp such that the projection area formed on the ground of the vehicle rear portion satisfies the following formula:

$$p = \vert AB \vert ,$$

wherein p is the minimum distance of the boundary of the projection area to the rear end of the vehicle in the front-rear direction of the vehicle, and |AB|; is the maximum distance of the opening trajectory of the tailgate to the rear end of the vehicle in the front-rear direction of the vehicle; and
control, when the open state of the tailgate to be used is the fully open state, the projection position of the projection lamp such that the projection area formed on the ground of the rear of the vehicle satisfies the following formula:

$$p = \{ \begin{matrix}\vert AC \vert & h \geq Hc \\ \vert AE \vert & h < Hc\end{matrix}$$

wherein p is the minimum distance of the boundary of the projection area to the rear end of the vehicle in the front-rear direction of the vehicle, |AG| is the maximum distance of the opening trajectory of the tailgate to the rear end of the vehicle in the front-rear direction of the vehicle, h is the height of the vehicle user, Hc is the distance from the farthest trajectory point from the rear end of the vehicle in the front-rear direction in the tailgate opening trajectory to the ground in the up-down direction of the vehicle, and |AE|, is the distance from a trajectory point corresponding to the height of the vehicle user in the front-rear direction of the vehicle in the opening trajectory of the tailgate to the rear end of the vehicle.

The controller may be configured to: acquire, after the projection lamp projects light and before controlling the opening or closing of the tailgate, a position of the vehicle user according to the sensor data acquired by the third sensor; determine whether the acquired position of the vehicle user is in the projection area or further away from the rear end of the vehicle than the projection area; and control, when determining that the position at which the vehicle user is standing is in the projection area or further away from the rear end of the vehicle than the projection area, the opening or closing of the tailgate.

The first sensor includes a front camera installed on a front portion of the vehicle and a rear camera installed on a rear portion of the vehicle; and the controller is configured to: determine, according to a user terminal carried by the vehicle user, the direction in which the vehicle user is located relative to the vehicle when the vehicle user approaches the vehicle; and activate a corresponding one of the front camera and the rear camera according to a direction in which the determined vehicle user is located relative to the vehicle.

According to the present disclosure, there is provided a method for tailgate control having a fully open state that fully opens the storage space of the rear portion of the vehicle or a semi-open state that opens a lower half portion of the storage space of the rear portion of the vehicle, wherein the method includes a step of acquiring portable information of a vehicle user according to at least sensor data in front and rear of the vehicle; a step of acquiring storage information of a storage space according to sensor data of the storage space; and a step of determining the open state of a tailgate to be used according to the acquired portable information of the vehicle user and the acquired storage information of the storage space,

The step of determining the open state of a tailgate to be used according to the acquired portable information of the vehicle user and the acquired storage information of the storage space includes: a step of acquiring an opening size of the storage space including an opening length in a vehicle up-down direction and an opening length in the vehicle left-right direction in a state in which a tailgate is semi-open; a step of determining whether the vehicle user is carrying the object according to the portable information of the vehicle user; a step of determining, when determining that the vehicle user carries the object, whether the size of the object projected in a specific direction falls within an opening size range of the storage space in a state in which the tailgate is semi-open, according to the portable information of the vehicle user; a step of determining, when determining that the size of the object projected in the specific direction falls within the opening size range of the storage space in a state in which the tailgate is semi-open, or when determining that the vehicle user does not carry the object, whether a height of an object stored in the storage space is equal to or greater than the opening length of the storage space in the up-down direction of the vehicle in the state in which the tailgate is semi-open, according to the storage information of the storage space; a step of determining, when determining that the height of the object stored in the storage space is equal to or greater than the opening length of the storage space in the up-down direction of the vehicle in a state in which the tailgate is semi-open, the open state of the tailgate to be used as the fully open state; a step of determining, when determining that the height of an object stored in a storage space is smaller than the opening length of the storage space in the up-down direction of the vehicle in a state in which the tailgate is semi-open, the open state of a tailgate to be used as the semi-open state, and a step of determining, when determining that the size of the object projected in a specific direction does not fall within an opening size range of the storage space a state in which the tailgate is semi-open, the open state of the tailgate to be used as a fully open state.

The method for tailgate control may further include a step of acquiring a height of a vehicle user according to at least sensor data in front and rear of the vehicle; and a step of calculating, after determining the open state of the tailgate to be used, a reference value for determining whether a vehicle rear space is sufficient according to the acquired height of the vehicle user and the determined open state of the tailgate to be used.

The step of calculating a reference value, when the open state of the tailgate to be used is the semi-open state, may include a step of calculating a reference value using the following formula:

$$m = \vert AB \vert + n ,$$

wherein m is the reference value, |AB| is the maximum distance of the opening trajectory of the tailgate to the rear end of the vehicle in the front-rear direction, and n is the preset side length of the vehicle user; and
when the opening state of the tailgate to be used is a fully open state, it may be configured to calculate a reference value using the following formula:

$$m = \{ \begin{matrix}\vert AC \vert + n & h \geq Hc \\ \vert AE \vert + n & h < Hc\end{matrix}$$

wherein m is the reference value, |AC| is the maximum distance of the opening trajectory of the tailgate to the rear end of the vehicle in the front-rear direction of the vehicle, n is the preset side length of the vehicle user, h is the height of the vehicle user, Hc is the distance from the farthest trajectory point from the rear end of the vehicle in the front-rear direction in the tailgate opening trajectory to the ground in the up-down direction of the vehicle, and JAEL, is the distance from a trajectory point corresponding to the height of the vehicle user in the front-rear direction of the vehicle in the opening trajectory of the tailgate to the rear end of the vehicle.

The method for tailgate control may further include a step of acquiring the length of the vehicle rear space in the front-rear direction of the vehicle according to the sensor data of the vehicle rear space; a step of comparing the acquired length of the vehicle rear space in the front-rear direction of the vehicle with the calculated reference value to determine whether the length of the vehicle rear space in the front-rear direction of the vehicle is greater than the reference value; a step of determining that the vehicle rear space is sufficient when the length of the vehicle rear space in the front-rear direction of the vehicle is greater than the reference value; and a step of determining that the vehicle rear space is insufficient when the length of the vehicle rear space in the front-rear direction of the vehicle is less than or equal to the reference value.

The method for tailgate control may further include a step of generating and outputting, when determining that the vehicle rear space is insufficient, a notification for asking whether the vehicle is moving; a step of determining whether the vehicle user inputs a control command for moving the vehicle; a step of activating, when determining that the vehicle user inputs the control command for moving the vehicle, an automatic parking function of an advanced driving assistance system to move the vehicle until the vehicle rear space becomes sufficient; and a step of controlling the opening of the tailgate after determining that the vehicle rear space is sufficient.

The method for tailgate control may further include a step of determining, before determining the open state of the tailgate to be used, whether the vehicle user inputs a control command for opening the tailgate; and determining, when determining that the vehicle user inputs the control command for opening the tailgate, the open state of the tailgate to be used.

The step of determining whether the vehicle user inputs a control command for moving the vehicle or a control command for opening of the tailgate includes: a step of determining whether the vehicle user maintains a predetermined distance from the tailgate within a reference time according to a user terminal carried by the vehicle user; and a step of determining, when the vehicle user maintains the predetermined distance from the tailgate within the reference time, that the vehicle user inputs a control command for moving the vehicle or a control command for opening the tailgate.

The method for tailgate control may further include a step of determining, after controlling the opening of the tailgate, whether the vehicle user inputs a control command for closing the tailgate; and a step of controlling, when determining that the vehicle user inputs the control command for closing the tailgate, the closing of the tailgate.

The step of determining whether the vehicle user inputs a control command for closing the tailgate may include: a step of acquiring, after controlling the tailgate to be opened in a semi-open state, a hand gesture of the vehicle user according to the sensor data of the rear of the tailgate in a state in which the tailgate is semi-open; a step of acquiring, after controlling the tailgate to be opened in a fully open state, a hand gesture of the vehicle user according to the sensor data of the rear of the vehicle; a step of determining whether the acquired hand gesture of the vehicle user is a hand gesture for closing the preset tailgate; and a step of determining, when the hand gesture of the vehicle user is a gesture for closing the preset tailgate, that the vehicle user inputs a control command for closing the tailgate.

The method for tailgate control may further include a step of controlling a projection lamp to project light onto the ground of the rear of the vehicle to indicate a position where the user is standing, before controlling the opening of the tailgate when determining that the rear space of the vehicle is sufficient, or before controlling the closing of the tailgate when determining that the vehicle user inputs a control command for closing the tailgate.

The step of controlling the projection lamp includes:
a step of controlling, when the open state of the tailgate to be used is the semi-open state, the projection position of the projection lamp such that the projection area formed on the ground of the rear of the vehicle satisfies the following formula:

$$p = \vert AB \vert ,$$

wherein p is the minimum distance of the boundary of the projection area to the rear end of the vehicle in the front-rear direction of the vehicle, and |AB| is the maximum distance of the opening trajectory of the tailgate to the rear end of the vehicle in the front-rear direction of the vehicle; and
a step of controlling, when the open state of the tailgate is the fully open state, the projection position of the projection lamp such that the projection area formed on the ground of the rear of the vehicle satisfies the following formula:

$$p = \{ \begin{matrix}\vert AC \vert & h \geq Hc \\ \vert AE \vert & h < Hc\end{matrix}$$

wherein p is the minimum distance of the boundary of the projection area to the rear end of the vehicle in the front-rear direction of the vehicle, |AG| is the maximum distance of the opening trajectory of the tailgate to the rear end of the vehicle in the front-rear direction of the vehicle, h is the height of the vehicle user, Hc is the distance from the farthest trajectory point from the rear end of the vehicle in the front-rear direction in the tailgate opening trajectory to the ground in the up-down direction of the vehicle, and |AE| is the distance from a trajectory point corresponding to the height of the vehicle user in the front-rear direction of the vehicle in the opening trajectory of the tailgate to the rear end of the vehicle.

The method for tailgate control may further include a step of acquiring, after the projection lamp projects light and before controlling the opening or closing of the tailgate, a position of the vehicle user according to the sensor data of the vehicle rear space; a step of determining whether the acquired position of the vehicle user is in the projection area or further away from the rear end of the vehicle than the projection area; and a step of controlling, when determining that the position at which the vehicle user is standing is in the projection area or further away from the rear end of the vehicle than the projection area, the opening or closing of the tailgate.

The present disclosure adopts the foregoing technical solutions to acquire the following advantageous effects: The present disclosure may select an open state of a tailgate to be used between a fully open state and a semi-open state of the tailgate according to portable information of a vehicle user and storage information of a storage space, thereby preventing the time for taking out or loading an object from being extended due to an erroneous selection by the user. The present disclosure may determine a situation in which a rear space of a vehicle is insufficient, and activate an automatic parking function of ADAS that may move the vehicle in a timely manner so that the rear space of the vehicle may be sufficiently secured according to a control command of a vehicle user without opening the tailgate when the rear space of vehicle is insufficient. The present disclosure may project light with a projection lamp before opening or closing a tailgate, and the projection position of the projection lamp is determined according to the open state of the tailgate to be used and the height of a vehicle user, thereby indicating a position where the vehicle user is safely standing in various situations, and ensuring the safety of the vehicle user by preventing the tailgate from colliding with the vehicle user when opening or closing. In the present disclosure, a user may command the closing of a tailgate through a hand gesture, and the tailgate begins to be closed only after waiting until the user leaves the tailgate area, so that convenience and safety of the tailgate closing may be improved.

The effects of the present disclosure are not limited to those mentioned above, and other effects not mentioned will be clearly understood by those skilled in the art from the following description.

The system and method for tailgate control according to the present disclosure may enable selection of an open state of a tailgate to be used between the fully open state or the semi-open state of the tailgate according to the portable information of the vehicle user and the storage information of the storage space, thereby preventing an extended time for taking out or loading an object due to an erroneous selection by the user.

In addition, according to the system and method for tailgate control according to the present disclosure, the front camera and the rear camera may be a wide-angle camera or an ultra-wide-angle camera having an angle of view of 180° or more, and when the vehicle user approaches the vehicle, the portable information of the vehicle user and the height information of the vehicle user are acquired, so that the open state of the tailgate to be used may be determined in advance.

In addition, according to the system and method for tailgate control, it may be possible to determine a situation in which the rear space of the vehicle is insufficient, and activate the automatic parking function of the ADAS that may move the vehicle in a timely manner so that the rear space of a vehicle may be sufficiently secured according to a control command of the vehicle user without opening the tailgate when the vehicle rear space is insufficient.

In addition, according to the system and method for tailgate control, before opening or closing the tailgate, light may be projected by the projection lamp, and the projection position of the projection lamp is determined according to the open state of the tailgate to be used and the height of the vehicle user, thereby indicating a position where the vehicle user is safely standing in various situations, and ensuring the safety of the vehicle user by preventing the tailgate from colliding with the vehicle user when opening or closing.

In addition, according to the system and method for tailgate control, the control command output by the vehicle user may be of various types, and may be input by a convenient method such as, for example, a hand gesture operation or a voice signal. Specifically, the user may command the tailgate to be closed through a hand gesture, and the tailgate starts to be closed only after the user waits for the tailgate to leave the tailgate area, so that convenience and safety of the tailgate closing may be improved.

The various example embodiment(s) of the present disclosure are not exhaustive lists of all possible combinations, but are intended to describe representative aspects of the present disclosure, and the description of the various embodiments may be applied independently or in combinations of two or more.

The description given in reference to the foregoing example embodiment(s) is merely illustrative of the technical solutions of the present disclosure, and is not intended to limit the present disclosure to the precise form described or to constitute the complete form without any omission. It is obvious that those skilled in the art may make many changes and modifications in accordance with the above guidelines. The selection and description of the example embodiment(s) are intended to illustrate the specific principles of the present disclosure and its practical application, thereby facilitating a person skilled in the art to understand and implement the various example embodiment(s) and the various selections and modifications thereof. The scope of protection of the present disclosure is intended to be defined by the appended claims and their equivalent forms.

What is claimed is:

1. A system comprising:
a first sensor installed on at least one of a front portion or a rear portion of a vehicle, and configured to acquire first sensor data of a surrounding environment of the vehicle;
a second sensor installed in a storage space of the vehicle and configured to acquire second sensor data of the storage space; and
a control circuit configured to:
acquire, based on the first sensor data, object information related to an object in the surrounding environment of the vehicle;
acquire, based on the second sensor data, storage information related to the storage space;
select, based on the object information and the storage information, a position of a rear gate of the vehicle, wherein the selected position is one of:
a fully open position in which the rear gate fully uncovers an opening of the storage space, or
a semi-open position in which the rear gate partially covers the opening of the storage space; and
control the rear gate to move to the selected position.

2. The system of claim 1, wherein the control circuit is configured to select the position of the rear gate by:
acquiring a size of a partial opening of the storage space with the rear gate in the semi-open position, wherein the size comprises an opening height in a vertical direction of the vehicle and an opening length in a lateral direction of the vehicle;
determining, based on the object information, whether the object is being carried by a vehicle user;
determining, based on determining that the object is being carried by the vehicle user, whether a size of the object oriented in a specific direction falls within the size of the partial opening with the rear gate in the semi-open position;
determine, based on the storage information and based on determining that the size of the object oriented in the specific direction falls within the size of the partial opening with the rear gate in the semi-open position, whether a height of a second object that is stored in the storage space is greater than or equal to the opening height of the storage space with the rear gate in the semi-open position; and
select the position of the rear gate by selecting one of:
the fully open position, based on determining that the height of the second object is greater than or equal to the opening height of the storage space with the rear gate in the semi-open position; or
the semi-open position, based on determining that the height of the second object is less than the opening height of the storage space with the rear gate in the semi-open position.

3. The system of claim 2, wherein the control circuit is configured to select the position of the rear gate by:
selecting the fully open position based on determining that the size of the object oriented in the specific direction falls beyond the size of the partial opening with the rear gate in the semi-open position.

4. The system of claim 2, wherein the control circuit is further configured to:
acquire, based on the first sensor data, a height of the vehicle user; and
determine, after selecting the position of the rear gate and based on the height of the vehicle user and the selected position of the rear gate, a reference value for determining whether a space behind the vehicle is sufficient for opening the rear gate.

5. The system of claim 4, further comprising:
a third sensor installed on the rear portion of the vehicle and configured to acquire third sensor data of the space behind the vehicle,
wherein the control circuit is configured to determine whether the space behind the vehicle is sufficient for opening the rear gate by:
acquiring, based on the third sensor data, a longitudinal length of the space behind the vehicle;
determining that:
the space behind the vehicle is sufficient for opening the rear gate based on the longitudinal length of the space behind the vehicle being greater than the reference value; or
the space behind the vehicle is insufficient for opening the rear gate based on the longitudinal length of the space behind the vehicle being less than or equal to the reference value.

6. The system of claim 5, wherein the control circuit is configured to control the rear gate by:
outputting, based on determining that the space behind the vehicle is insufficient, a notification for asking whether to move the vehicle;
activating, based on receiving a user input for moving the vehicle, an automatic parking function to move the vehicle until the space behind the vehicle becomes sufficient for opening the rear gate; and
controlling, after determining that the space behind the vehicle is sufficient for opening the rear gate, the rear gate to open.

7. The system of claim 1, wherein the control circuit is configured to select the position of the rear gate by:
selecting the position of the rear gate further based on a user control command for opening the rear gate.

8. The system of claim 6, wherein the control circuit is further configured to:
determine, based on a user terminal associated with the vehicle user, whether the vehicle user stays, for at least a reference time duration, within a predetermined distance from the rear gate; and
based on the vehicle user staying within the predetermined distance from the rear gate for at least the reference time duration, control the vehicle to move or control the rear gate to open.

9. The system of claim 6, wherein the control circuit is further configured to:
determine, after controlling the rear gate to open, whether a user control command for closing the rear gate has been input; and
control, based on determining that the user control command for closing the rear gate has been input, the rear gate to close.

10. The system of claim 9, further comprising:
a fourth sensor installed in a lower portion of the rear gate, wherein the lower portion of the rear gate is configured to, in a closed position of the rear gate, cover a lower portion of the opening of the storage space, and wherein the fourth sensor is configured to acquire fourth sensor data of a rear of the rear gate in the semi-open position,
wherein the control circuit is further configured to perform one of:
acquiring, after controlling the rear gate to open to the semi-open position and based on the fourth sensor data, a hand gesture of the vehicle user; or
acquiring, after controlling the rear gate to open to the fully open position and based on the first sensor data, the hand gesture of the vehicle user, and
wherein the control circuit is further configured to:
determine whether the acquired hand gesture of the vehicle user is a predetermined hand gesture for closing the rear gate; and
control, based on determining that the hand gesture of the vehicle user is the predetermined hand gesture for closing the rear gate, the rear gate to close.

11. The system of claim 9, further comprising:
a projection lamp installed on the rear portion of the vehicle and configured to project light onto a ground surface behind the vehicle to indicate a position of the vehicle user,
wherein the control circuit is configured to cause the projection lamp to project the light before:
controlling the rear gate to open based on determining that the space behind the vehicle is sufficient for opening the rear gate, or
controlling the rear gate to close based on receiving a user input for closing the rear gate.

12. The system of claim 11, wherein the control circuit is configured to control the projection lamp by:
controlling the projection lamp to project the light at a projection area, wherein a minimum longitudinal distance between a rear end of the vehicle and the projection area is one of:
based on the selected position of the rear gate being the semi-open position, a first maximum longitudinal distance between the rear end of the vehicle and a first movement trajectory of the rear gate between a closed position and the semi-open position;
based on the selected position of the rear gate being the fully open position and based on the height of the vehicle user being greater than or equal to a minimum height of the rear gate at the fully open position, a second maximum longitudinal distance between the rear end of the vehicle and a second movement trajectory of the rear gate between the closed position and the fully open position; or
based on the selected position of the rear gate being the fully open position and based on the height of the vehicle user being less than the minimum height of the rear gate at the fully open position, a longitudinal distance between the rear end of the vehicle and a point, on the second movement trajectory, that corresponds to the height of the vehicle user.

13. The system of claim 12, wherein the control circuit is further configured to:
after controlling the projection lamp to project the light and before controlling the rear gate to open or close, acquire, based on the third sensor data, the position of the vehicle user;
determine whether the acquired position of the vehicle user is in the projection area or further away from the rear end of the vehicle than the projection area; and
control, based on determining that the position of the vehicle user is further away from the rear end of the vehicle than the projection area, the rear gate to open or close.

14. The system of claim 1, wherein the first sensor comprises a front camera installed on the front portion of the vehicle and a rear camera installed on the rear portion of the vehicle,
wherein the control circuit is configured to:
determine, based on a user terminal associated with a vehicle user, a direction in which the vehicle user is located relative to the vehicle when the vehicle user approaches the vehicle; and
activate, based on the direction, a corresponding one of the front camera or the rear camera.

15. A method performed by a device associated with a vehicle, the method comprising:
acquiring, based on first sensor data of a surrounding environment of the vehicle, object information related to an object in the surrounding environment of the vehicle;
acquiring, based on second sensor data of a storage space of the vehicle, storage information related to the storage space;
selecting, based on the object information and the storage information, a position of a rear gate of the vehicle, wherein the selected position is one of:
a fully open position in which the rear gate fully uncovers an opening of the storage space, or
a semi-open position in which the rear gate partially covers the opening of the storage space; and
controlling the rear gate to move to the selected position.

16. The method of claim 15, wherein the selecting of the position of the rear gate comprises:
acquiring a size of a partial opening of the storage space with the rear gate in the semi-open position, wherein the size comprises an opening height in a vertical direction of the vehicle and an opening length in a lateral direction of the vehicle;
determining, based on the object information, whether the object is being carried by a vehicle user;
determining, based on determining that the object is being carried by the vehicle user, whether a size of the object oriented in a specific direction falls within the size of the partial opening with the rear gate in the semi-open position;
determining, based on the storage information and based on determining that the size of the object oriented in the specific direction falls within the size of the partial opening with the rear gate in the semi-open position, whether a height of a second object that is stored in the storage space is greater than or equal to the opening height of the storage space with the rear gate in the semi-open position; and
selecting the position of the rear gate by selecting one of:
the fully open position, based on determining that the height of the second object is greater than or equal to the opening height of the storage space with the rear gate in the semi-open position; or
the semi-open position, based on determining that the height of the second object is less than the opening height of the storage space with the rear gate in the semi-open position.

17. The method of claim 16, wherein the selecting of the position of the rear gate comprises:
selecting the fully open position based on determining that the size of the object oriented in the specific direction falls beyond the size of the partial opening with the rear gate in the semi-open position.

18. The method of claim 16, further comprising:
acquiring, based on the first sensor data, a height of the vehicle user; and
determining, after selecting the position of the rear gate and based on the height of the vehicle user and the selected position of the rear gate, a reference value for determining whether a space behind the vehicle is sufficient for opening the rear gate.

19. The method of claim 18, wherein the determining of whether the space behind the vehicle is sufficient for opening the rear gate comprises:
acquiring, based on third sensor data of the space behind the vehicle, a longitudinal length of the space behind the vehicle;
determining that:
the space behind the vehicle is sufficient for opening the rear gate based on the longitudinal length of the space behind the vehicle being greater than the reference value; or
the space behind the vehicle is insufficient for opening the rear gate based on the longitudinal length of the space behind the vehicle being less than or equal to the reference value.

20. The method of claim 19, wherein the controlling of the rear gate comprises:
outputting, based on determining that the space behind the vehicle is insufficient, a notification for asking whether to move the vehicle;
activating, based on receiving a user input for moving the vehicle, an automatic parking function to move the vehicle until the space behind the vehicle becomes sufficient for opening the rear gate; and
controlling, after determining that the space behind the vehicle is sufficient for opening the rear gate, the rear gate to open.

21. The method of claim 15, wherein the selecting of the position of the rear gate comprises:
selecting the position of the rear gate further based on a user control command for opening the rear gate.

22. The method of claim 20, further comprising:
determining, based on a user terminal associated with the vehicle user, whether the vehicle user stays, for at least a reference time duration, within a predetermined distance from the rear gate; and
based on the vehicle user staying within the predetermined distance from the rear gate for at least the reference time duration, controlling the vehicle to move or controlling the rear gate to open.

23. The method of claim 20, further comprising:
determining, after controlling the rear gate to open, whether a user control command for closing the rear gate has been input; and
controlling, based on determining that the user control command for closing the rear gate has been input, the rear gate to close.

24. The method of claim 23, further comprising one of:
acquiring, after controlling the rear gate to open to the semi-open position and based on fourth sensor data of a rear of the rear gate in the semi-open position, a hand gesture of the vehicle user; or
acquiring, after controlling the rear gate to open to the fully open position and based on the first sensor data, the hand gesture of the vehicle user,
wherein the method further comprises:
determining whether the acquired hand gesture of the vehicle user is a predetermined hand gesture for closing the rear gate; and
controlling, based on determining that the hand gesture of the vehicle user is the predetermined hand gesture for closing the rear gate, the rear gate to close.

25. The method of claim 23, further comprising:
controlling a projection lamp to project light onto a ground surface behind the vehicle to indicate a position of the vehicle user, before:
controlling the rear gate to open based on determining that the space behind the vehicle is sufficient for opening the rear gate, or
controlling the rear gate to close based on receiving a user input for closing the rear gate.

26. The method of claim 25, wherein the controlling of the projection lamp comprises:
controlling the projection lamp to project the light at a projection area, wherein a minimum longitudinal distance between a rear end of the vehicle and the projection area is one of:
based on the selected position of the rear gate being the semi-open position, a first maximum longitudinal distance between the rear end of the vehicle and a first movement trajectory of the rear gate between a closed position and the semi-open position;
based on the selected position of the rear gate being the fully open position and based on the height of the vehicle user being greater than or equal to a minimum height of the rear gate at the fully open position, a second maximum longitudinal distance between the rear end of the vehicle and a second movement trajectory of the rear gate between the closed position and the fully open position; or
based on the selected position of the rear gate being the fully open position and based on the height of the vehicle user being less than the minimum height of the rear gate at the fully open position, a longitudinal distance between the rear end of the vehicle and a point, on the second movement trajectory, that corresponds to the height of the vehicle user.

27. The method of claim 26, further comprising:
after the controlling of the projection lamp to project the light and before the controlling of the rear gate to open or close, acquiring, based on the third sensor data, the position of the vehicle user;
determining whether the acquired position of the vehicle user is in the projection area or further away from the rear end of the vehicle than the projection area; and
controlling, based on determining that the position of the vehicle user is further away from the rear end of the vehicle than the projection area, the rear gate to open or close.
